(19) United States
(12) Patent Application Publication
(10) Pub. No.: US 2008/0211817 A1
(43) Pub. Date: Sep. 4, 2008

(54) Internet-based application profile database server system for updating graphic application profiles (GAPS) stored within the multi-mode parallel graphics rendering system of client machines running one or more graphic applications

(76) Inventors: Reuven Bakalash, Shdema (IL); Yaniv Leviathan, Savyon (IL)

Correspondence Address: Thomas J. Perkowski, Esq., P.C., 1266 East Main Street, Stamford, CT, 06902, US

(21) Appl. No.: 11/980,318

(22) Filed: Oct. 30, 2007

Related U.S. Application Data
(63) Continuation of application No. 11/789,039, filed on Apr. 23, 2007.
Application No. 11/789,039 is a continuation-in-part of application No. 11/655,735, filed on Jan. 18, 2007.
Application No. 11/655,735 is a continuation-in-part of application No. 11/386,454, filed on Mar. 22, 2006.
Application No. 11/386,454 is a continuation-in-part of application No. 11/340,402, filed on Jan. 25, 2006.
Application No. 11/789,039 is a continuation-in-part of application No. 10/579,682, filed on Mar. 23, 2007.
(60) Provisional application No. 60/647,146, filed on Jan. 25, 2005.
(60) Provisional application No. 60/523,084, filed on Nov. 19, 2003.

(51) Int. Cl. G06F 15/80

(52) U.S. Cl. 345/505

(57) ABSTRACT

An Internet-based application profile database server system for updating, graphic application profiles (GAPs) stored within a behavioral profile database in a multi-mode parallel graphics rendering system (MMPGRS) embodied within a client machine running one or more graphic applications. Each graphics application has a graphic application profile (GAP), and each client machine has a behavior profile associated with the running of a particular graphics application on said client machine. The Internet-based application profile database server system includes an Internet server, interfaced with a RDBMS, for communicating with one or more client machines over a communication network, such as the Internet, and programming one or more GAPs in each client machine so that the client machine supports users with high graphics performance through adaptive multi-modal parallel graphics operation.

### CROSS-REFERENCE TO RELATED CASES

The present application is a Continuation of U.S. application Ser. No. 11/789,039 filed Apr. 23, 2007; which is a Continuation-in-Part (CIP) of the following Applications: U.S. application Ser. No. 11/655,735 filed Jan. 18, 2007; Provisional Application Ser. No. 60/759,608 filed Jan. 18, 2006; U.S. application Ser. No. 11/386,454 filed Mar. 22, 2006; U.S. application Ser. No. 11/340,402 filed Jan. 25, 2006; which is based on Provisional Application: 60/647,146 filed Jan. 25, 2005; U.S. application Ser. No. 10/579,682 filed May 17, 2006; which is a National Stage Entry of International Application No. PCT/IL2004/001069 filed Nov. 19, 2004; which is based on Provisional Application Ser. No. 60/523,084 filed Nov. 19, 2003; each said application being commonly owned by Lucid Information Technology, Ltd., and being incorporated herein by reference as if set forth fully herein.

### BACKGROUND OF INVENTION

1. Field of Invention

The present invention relates generally to the field of computer graphics rendering, and more particularly, ways of and means for improving the performance of parallel graphics rendering processes supported on multiple GPU-based 3D graphics platforms associated with diverse types of computing machinery.

2. Brief Description of the State of Knowledge in the Art

There is a great demand for high performance three-dimensional (3D) computer graphics systems in the fields of product design, simulation, virtual-reality, video-gaming, scientific research, and personal computing (PC). Clearly a major goal of the computer graphics industry is to realize real-time photo-realistic 3D imagery on PC-based workstations, desktops, laptops, and mobile computing devices.

In general, there are two fundamentally different classes of machines in the 3D computer graphics field, namely: (1) Object-Oriented Graphics Systems, also known as Graphical Display List (GDL) Graphics Systems, wherein 3D scenes are represented as a complex of geometric objects (primitives) in 3D continuous geometric space, and 2D views or images of such 3D scenes are computed using geometrical projection, ray tracing, and light scattering/reflection/absorption modeling techniques, typically based upon laws of physics; and (2) VOlume ELement (VOXEL) Graphics Systems, wherein 3D scenes and objects are represented as a complex of voxels (x,y,z volume elements) represented in 3D Cartesian Space, and 2D views or images of such 3D voxel-based scenes are also computed using geometrical projection, ray tracing, and light scattering/reflection/absorption modeling techniques, again typically based upon laws of physics. Examples of early GDL-based graphics systems are disclosed in U.S. Pat. No. 4,862,155, whereas examples of early voxel-based 3D graphics systems are disclosed in U.S. Pat. No. 4,985,856, each incorporated herein by reference in its entirety.

In the contemporary period, most PC-based computing systems include a 3D graphics subsystem based the “Object-Orient Graphics” (or Graphical Display List) system design. In such graphics system design, “objects” within a 3D scene are represented by 3D geometrical models, and these geometrical models are typically constructed from continuous-type 3D geometric representations including, for example, 3D straight line segments, planar polygons, polyhedra, cubic polynomial curves, surfaces, volumes, circles, and quadratic objects such as spheres, cones, and cylinders. These 3D geometrical representations are used to model various parts of the 3D scene or object, and are expressed in the form of mathematical functions evaluated over particular values of coordinates in continuous Cartesian space. Typically, the 3D geometrical representations of the 3D geometric model are stored in the format of a graphical display list (i.e. a structured collection of 2D and 3D geometric primitives). Currently, planar polygons, mathematically described by a set of vertices, are the most popular form of 3D geometric representation.

Once modeled using continuous 3D geometrical representations, the 3D scene is graphically displayed (as a 2D view of the 3D geometrical model) along a particular viewing direction, by repeatedly scan-converting the graphical display list. At the current state of the art, the scan-conversion process can be viewed as a “computational geometry” process which involves the use of (i) a geometry processor (i.e. geometry processing subsystem or engine) as well as a pixel processor (i.e. pixel processing subsystem or engine) which together transform (i.e. project, shade and color) the display-list objects and bit-mapped textures, respectively, into an unstructured matrix of pixels. The composed set of pixel data is stored within a 2D frame buffer (i.e. Z buffer) before being transmitted to and displayed on the surface of a display screen.

A video processor/engine refreshes the display screen using the pixel data stored in the 2D frame buffer. Any changes in the 3D scene requires that the geometry and pixel processors repeat the whole computationally-intensive pixel-generation pipeline process, again and again, to meet the requirements of the graphics application at hand. For every small change or modification in viewing direction of the human system user, the graphical display list must be manipulated and repeatedly scan-converted. This, in turn, causes both computational and buffer contention challenges which slow down the working rate of the graphics system. To accelerate this computationally-intensive pipeline process, custom hardware including geometry, pixel and video engines, have been developed and incorporated into most conventional “graphics display-list” system designs.

In order to render a 3D scene (from its underlying graphical display lists) and produce high-resolution graphical projections for display on a display device, such as a LCD panel, early 3D graphics systems attempted to relieve the host CPU of computational loading by employing a single graphics pipeline comprising a single graphics processing unit (GPU), supported by video memory.

As shown in FIG. 1A, a typical PC based graphic architecture has an external graphics card (105). The main components of the graphics card (105) are the graphics processing unit (GPU) and video memory, as shown. As shown, the graphic card is connected to the display (106) on one side, and the CPU (101) through bus (e.g. PCIExpress) (107) and Memory Bridge (103, termed also “chipset”, e.g. 975 by Intel), on the other side.

FIG. 1B illustrates a rendering of three successive frames by a single GPU. The application, assisted by graphics library, creates a stream of graphics commands and data describing a 3D scene. The stream is pipelined through the GPU's geometry and pixel subsystems to create a bitmap of pixels in the Frame Buffer, and finally displayed on a display screen. A sequence of successive frames generates a visual illusion of a dynamic picture.

As shown in FIG. 1B, the structure of a GPU subsystem on a graphic card comprises: a video memory which is external to GPU, and two 3D engines: (i) a transform bound geometry subsystem (224) for processing 3D graphics primitives; (ii) and a fill bound pixel subsystem (225). The video memory shares its storage resources among geometry buffer (222) through which all geometric (i.e. polygonal) data is transferred, commands buffer, texture buffers (223), and Frame Buffer (226).

Limitations of a single graphics pipeline rise from its typical bottlenecks. The first potential bottleneck (221) stems from transferring data from CPU to GPU. Two other bottlenecks are video memory related: geometry data memory limits (222), and texture data memory limits (223). There are two additional bottlenecks inside the GPU: transform bound (224) in the geometry subsystem, and fragment rendering (225) in pixel subsystem. These bottlenecks determine overall throughput. In general, the bottlenecks vary over the course of a graphics application.

In high-performance graphics applications, the number of computations required to render a 3D scene and produce high-resolution graphical projections, greatly exceeds the capabilities of systems employing a single GPU graphics subsystem. Consequently, the use of parallel graphics pipelines, and multiple graphics processing units (GPUs), have become the rule for high-performance graphics system architecture and design, in order to relieve the overload presented by the different bottlenecks associated with single GPU graphics subsystems.

In FIG. 2A, there is shown an advanced chipset (e.g. Bearlake by Intel) having two buses (107, 108) instead of one, and allowing the interconnection of two external graphics cards in parallel: primary card (105) and secondary card (104), to share the computation load associated with the 3D graphics rendering process. As shown, the display (106) is attached to the primary card (105). It is anticipated that even more advanced commercial chipsets with >2 busses will appear in the future, allowing the interconnection of more than two graphic cards.

As shown in FIG. 2B, the general software architecture of prior art graphic system (200) comprises: the graphics application (201), standard graphics library (202), and vendor's GPU driver (203). This graphic software environment resides in the “program space” of main memory (102) on the host computer system. As shown, the graphic application (201) runs in the program space, building up the 3D scene, typically as a data base of polygons, each polygon being represented as a set of vertices. The vertices and others components of these polygons are transferred to the graphic card(s) for rendering, and displayed as a 2D image, on the display screen.

In FIG. 2C, the structure of a GPU subsystem on the graphics card is shown as comprising: a video memory disposed external to the GPU, and two 3D engines: (i) a transform bound geometry subsystem (224) for processing 3D graphics primitives; and (ii) a fill bound pixel subsystem (225). The video memory shares its storage resources among geometry buffer (222), through which all geometric (i.e. polygonal) data is transferred to the commands buffer, texture buffers (223), and Frame Buffer FB (226).

As shown in FIG. 2C, the division of graphics data among GPUs reduces (i) the bottleneck (222) posed by the video memory footprint at each GPU, (ii) the transform bound processing bottleneck (224), and (iii) the fill bound processing bottleneck (225).

However, when using a multiple GPU graphics architecture of the type shown in FIGS. 2A through 2C, there is a need to distribute the computational workload associated with interactive parallel graphics rendering processes. To achieve this objective, two different kind of parallel rendering methods have been applied to PC-based dual GPU graphics systems of the kind illustrated in FIGS. 2A through 2C, namely: the Time Division Method of Parallel Graphics Rendering illustrated in FIG. 2D; and the Image Division Method of Parallel Graphics Rendering illustrated in FIG. 2E.

Notably, a third type of method of parallel graphics rendering, referred to as the Object Division Method, has been developed over the years and practived exclusively on complex computing platforms requiring complex and expensive hardware platforms for compositing the pixel output of the multiple graphics pipelines. The Object Division Method, illustrated in FIG. 3A, can be found applied on conventional graphics platforms of the kind shown in FIG. 3, as well as specialized graphics computing platforms as described in US Patent Application Publication No. US 2002/0015055, assigned to Silicon Graphics, Inc. (SGI), published on Feb. 7, 2002, and incorporated herein by reference.

While the differences between the Image, Frame and Object Division Methods of Parallel Graphics Rendering will be described below, it will be helpful to first briefly describe the five (5) basic stages or phases of the parallel rendering process, which all three such methods have in common, namely:

(1) the Decomposition Phase, wherein the 3D scene or object is analyzed and its corresponding graphics display list data and commands are assigned to particular graphics pipelines available on the parallel multiple GPU-based graphics platform;

(2) the Distribution Phase, wherein the graphics display list data and commands are distributed to particular available graphics pipelines determined during the Decomposition Phase;

(3) the Rendering Phase, wherein the geometry processing subsystem/engine and the pixel processing subsystem/engine along each graphics pipeline of the parallel graphics platform uses the graphics display list data and commands distributed to its pipeline, and transforms (i.e. projects, shades and colors) the display-list objects and bit-mapped textures into a subset of unstructured matrix of pixels;

(4) the Recomposition Phase, wherein the parallel graphics platform uses the multiple sets of pixel data generated by each graphics pipeline to synthesize (or compose) a final set of pixels that are representative of the 3D scene (taken along the specified viewing direction), and this final set of pixel data is then stored in a frame buffer; and

(5) the Display Phase, wherein the final set of pixel data retrieved from the frame buffer; and provided to the screen of the device of the system. As will be explained below with reference to FIGS. 3B through 3D, each of these methods of parallel graphics rendering has both advantages and disadvantages.

### Image Division Method of Parallel Graphics Rendering

As illustrated in FIG. 2D, the Image Division (Sort-First) Method of Parallel Graphics Rendering distributes all graphics display list data and commands to each of the graphics pipelines, and decomposes the final view (i.e. projected 2D image) in Screen Space, so that, each graphical contributor (e.g. graphics pipeline and GPU) renders a 2D tile of the final view. This mode has a limited scalability due to the parallel overhead caused by objects rendered on multiple tiles. There are two image domain modes, all well known in prior art. They differ by the way the final image is divided among GPUs.

(1) The Split Frame Rendering mode divides up the screen among GPUs by continuous segments. e.g. two GPUs each one handles about one half of the screen. The exact division may change dynamically due to changing load across the screen image. This method is used in Vidia's SLI™ multiple-GPU graphics product.

(2) Tiled Frame Rendering mode divides up the image into small tiles. Each GPU is assigned tiles that are spread out across the screen, contributing to good load balancing. This method is implemented by ATI's Crossfire™ multiple GPU graphics card solution.

In image division, the entire database is broadcast to each GPU for geometric processing. However, the processing load at each Pixel Subsystem is reduced to about 1/N. This way of parallelism relieves the fill bound bottleneck (225). Thus, the image division method ideally suits graphics applications requiring intensive pixel processing.

### Time Division (DPlex) Method of Parallel Graphics Rendering

As illustrated in FIG. 2F, the Time Division (DPlex) Method of Parallel Graphics Rendering distributes all display list graphics data and commands associated with a first scene to the first graphics pipeline, and all graphics display list data and commands associated with a second/subsequent scene to the second graphics pipeline, so that each graphics pipeline (and its individual rendering node or GPU) handles the processing of a full, alternating image frame. Notably, while this method scales very well, the latency between user input and final display increases with scale, which is often irritating for the user. Each GPU is give extra time of N time frames (for N parallel GPUs) to process a frame. Referring to FIG. 3, the released bottlenecks are those of transform bound (224) at geometry subsystem, and fill bound (225) at pixel subsystem. Though, with large data sets, each GPU must access all of the data. This requires either maintaining multiple copies of large data sets or creating possible access conflicts to the source copy at the host swelling up the video memory bottlenecks (222, 223) and data transfer bottleneck (221).

### Object Division (Sort-Last) Method of Parallel Graphics Rendering

As illustrated in FIG. 3B, the Object Division (Sort-last) Method of Parallel Graphics Rendering decomposes the 3D scene (i.e. rendered database) and distributes graphics display list data and commands associated with a portion of the scene to the particular graphics pipeline (i.e. rendering unit), and recombines the partially rendered pixel frames, during recomposition. The geometric database is therefore shared among GPUs, offloading the geometry buffer and geometry subsystem, and even to some extend the pixel subsystem. The main concern is how to divide the data in order to keep load balance. An exemplary multiple-GPU platform of FIG. 3B for supporting the object-division method is shown in FIG. 3A. The platform requires complex and costly pixel compositing hardware which prevents its current application in a modern PC-based computer architecture.

Today, real-time graphics applications, such as advanced video games, are more demanding than ever, utilizing massive textures, abundance of polygons, high depth-complexity, anti-aliasing, multipass rendering, etc., with such robustness growing exponentially over time.

Clearly, conventional PC-based graphics system fail to address the dynamically changing needs of modern graphics applications. By their very nature, prior art PC-based graphics systems are unable to resolve the variety of bottlenecks that dynamically arise along graphics applications. Consequently, such prior art graphics systems are often unable to maintain a high and steady level of performance throughout a particular graphics application.

Indeed, a given pipeline along a parallel graphics system is only as strong as the weakest link of it stages, and thus a single bottleneck determines the overall throughput along the graphics pipelines, resulting in unstable frame-rate, poor scalability, and poor performance.

While each parallelization mode described above solves only part of the bottleneck dilemma, currently existing along the PC-based graphics pipelines, no one parallelization method, in and of itself, is sufficient to resolve all bottlenecks in demanding graphics applications.

Thus, there is a great need in the art for a new and improved way of and means for practicing parallel 3D graphics rendering processes in modern multiple-GPU based computer graphics systems, while avoiding the shortcomings and drawbacks of such prior art methodologies and apparatus.

### SUMMARY AND OBJECTS OF THE PRESENT INVENTION

Accordingly, a primary object of the present invention is to provide a new and improved method of and apparatus for practicing parallel 3D graphics rendering processes in modern multiple-GPU based computer graphics systems, while avoiding the shortcomings and drawbacks associated with prior art apparatus and methodologies.

Another object of the present invention is to provide such apparatus in the form of a multi-mode multiple graphics processing unit (GPU) based parallel graphics system having multiple graphics processing pipelines with multiple GPUs supporting a parallel graphics rendering process having time, frame and object division modes of operation, wherein each GPU comprises video memory, a geometry processing subsystem and a pixel processing subsystem, and wherein 3D scene profiling is performed in real-time, and the parallelization state/mode of the system is dynamically controlled to meet graphics application requirements.

Another object of the present invention is to provide a multi-mode parallel graphics rendering system having multiple graphics pipelines, each having a GPU and video memory, and supporting multiple modes of parallel graphics rendering using real-time graphics application profiling and configuration of the multiple graphics pipelines supporting multiple modes of parallel graphics rendering, namely, a time-division mode, a frame-division mode, and an object-division mode of parallel operation.

Another object of the present invention is to provide such a multi-mode parallel graphics rendering system, which is capable of dynamically handling bottlenecks that are automatically detected during any particular graphics application running on the host computing system.

Another object of the present invention is to provide such a multi-mode parallel graphics rendering system, wherein different parallelization schemes are employed to reduce pipeline bottlenecks, and increase graphics performance.

Another object of the present invention is to provide such a multi-mode parallel graphics rendering system, wherein image, time and object division methods of parallelization are implemented on the same parallel graphics platform.

Another object of the present invention is to provide a novel method of multi-mode parallel graphics rendering that can be practiced on a multiple GPU-based PC-level graphics system, and dynamically alternating among time, frame and object division modes of parallel operation, in real-time, during the course of graphics application, and adapting the optimal method to the real time needs of the graphics application.

Another object of the present invention is to provide such a multi-mode parallel graphics rendering system, which is capable of supervising the performance level of a graphic application by dynamically adapting different parallelization schemes to solve instantaneous bottlenecks along the graphic pipelines thereof.

Another object of the present invention is to provide such a multi-mode parallel graphics rendering system, having run time configuration flexibility for various parallel schemes to achieve the best parallel performance.

Another object of the present invention is to provide such a multi-mode parallel graphics rendering system having architectural flexibility and real-time profiling and control capabilities which enable utilization of different modes for high and steady performance along the application running on the associated host system.

Another object of the present invention is to provide a novel method of multi-mode parallel graphics rendering on a multiple GPU-based graphics system, which achieves improved system performance by using adaptive parallelization of multiple graphics processing units (GPUs), on conventional and non-conventional platform architectures, as well as on monolithic platforms, such as multiple GPU chips or integrated graphic devices (IGD).

Another object of the present invention is to provide a multi-mode parallel graphics rendering system, wherein bottlenecks are dynamically handled.

Another object of the present invention is to provide such a multi-mode parallel graphics rendering system, wherein stable performance is maintained throughout course of a graphics application.

Another object of the present invention to provide a multi-mode parallel graphics rendering system supporting software-based adaptive graphics parallelism for the best performance, seamlessly to the graphics application, and compliant with graphic standards (e.g. OpenGL and Direct3D).

Another object of the present invention is to provide a multi-mode parallel graphics rendering system, wherein all parallel modes are implemented in a single architecture.

Another object of the present invention is to provide a multi-mode parallel graphics rendering system, wherein the architecture is flexible, supporting fast inter-mode transitions.

Another object of the present invention is to provide a multi-mode parallel graphics rendering system which is adaptive to changing to meet the needs of any graphics application during the course of its operation.

Another object of the present invention is to provide a multi-mode parallel graphics rendering system which employs a user interaction detection (UID) subsystem for enabling the automatic and dynamic detection of the user's interaction with the host computing system.

Another object of the present invention is to provide such a multi-mode parallel graphics rendering system, continuously processes user-system interaction data, and automatically detects user-system interactivity (e.g. mouse click, keyboard depression, eye-movement, etc).

Another object of the present invention is to provide such a multi-mode parallel graphics rendering system the system, wherein absent preventive conditions (such as CPU bottlenecks and need for the same FB in successive frames), the user interaction detection (UID) subsystem enables timely implementation of the Time Division Mode only when no user-system interactivity is detected so that system performance is automatically optimized.

Another object of the present invention is to provide a multi-mode parallel graphics rendering system, which can be implemented using a software implementation of present invention.

Another object of the present invention is to provide a multi-mode parallel graphics rendering system, which can be realized using a hardware implementation.

Another object of the present invention is to provide a multi-mode parallel graphics rendering system, can be realized as chip implementation.

Another object of the present invention is to provide a multi-mode parallel graphics rendering system, which can be realized as an integrated monolithic implementation.

Another object of the present invention is to provide a multi-mode parallel graphics rendering system, which can be implemented using IGD technology.

Another object of the present invention is to provide a multi-mode parallel graphics rendering system, characterized by run-time configuration flexibility for various parallel schemes to achieve the best parallel performance.

Another object of the present invention is to provide a multi-mode parallel graphics rendering system that operates seamlessly to the application and is compliant with graphic standards (e.g. OpenGL and Direct3D).

Another object of the present invention is to provide a multi-mode parallel graphics rendering system, which can be implemented on conventional multi-GPU platforms replacing image division or time division parallelism.

Another object of the present invention is to provide a multi-mode parallel graphics rendering system, which enables the multiple GPU platform vendors to incorporate the solution in their systems supporting only image division and time division modes of operation.

Another object of the present invention is to provide such multiple GPU-based graphics system, which enables implementation using low cost multi-GPU cards.

Another object of the present invention is to provide a multi-mode parallel graphics rendering system implemented using IGD technology, and wherein it is impossible for the IGD to get disconnected by the BIOS when an external graphics card is connected and operating.

Another object of the present invention is to provide a multiple GPU-based graphics system, wherein a new method of dynamically controlled parallelism improves the system's efficiency and performance.

Another object of the present invention is to provide a multi-mode parallel graphics rendering system, which can be implemented using an IGD supporting more than one external GPU.

Another object of the present invention is to provide a multi-mode parallel graphics rendering system, which can be implemented using an IGD-based chipset having two or more IGDs.

Another object of the present invention is to provide a multi-mode parallel graphics rendering system, which employs a user interaction detection (UID) subsystem that enables automatic and dynamic detection of the user's interaction with the system, so that absent preventive conditions (such as CPU bottlenecks and need for the same FB in successive frames), this subsystem enables timely implementation of the Time Division Mode only when no user-system interactivity is detected, thereby achieving the highest performance mode of parallel graphics rendering at runtime, and automatically optimizing the system's graphics performance.

Another object of the present invention is to provide a novel multi-user computer network supporting a plurality of client machines, wherein each client machine employs the MMPGRS of the present invention based on a software architecture and responds to user-interaction input data streams from one or more network users who might be local each other as over a LAN, or be remote to each other as over a WAN or the Internet infrastructure.

Another object of the present invention is to provide a novel multi-user computer network supporting a plurality of client machines, wherein each client machine employs the MMPGRS of the present invention based on a hardware architecture and responds to user-interaction input data streams from one or more network users who might be local each other as over a LAN, or be remote to each other as over a WAN or the Internet infrastructure.

Another object of the present invention is to provide an Internet-based central application profile database (DB) server system for automatically updating, over the Internet, graphic application profiles (GAPs) within the MMPGRS of client machines.

Another object of the present invention is to provide such Internet-based central application profile database server system which ensures that each MMPGRS is optimally programmed at all possible times so that it quickly and continuously offers users high graphics performance through its adaptive multi-modal parallel graphics operation.

Another object of the present invention is to provide such an Internet-based central application profile database server system which supports a Web-based Game Application Registration and Profile Management Application, that provides a number of Web-based services, including:

(1) the registration of Game Application Developers within the RDBMS of the Server System;

(2) the registration of game applications with the RDBMS of the Central Application Profile Database Server System, by registered game application developers;

(3) the registration of each MMPGRS deployed on a client machine or server system having Internet-connectivity, and requesting subscription to periodic/automatic Graphic Application Profile (GAP) Updates (downloaded to the MMPGRS over the Internet) from the Central Application Profile Database Server System; and

(4) the registration of each deployed MMPGRS requesting the periodic uploading of its Game Application Profiles (GAPS)—stored in Behavorial Profile DB and Historical Repository—to the Central Application Profile Database Server System for the purpose of automated analysis and processing so as to formulate “expert” Game Application Profiles (GAPs) that have been based on robust user-experience and which are optimized for particular client machine configurations.

Another object of the present invention is to provide such an Internet-based central application profile database server system that enables the MMGPRS of registered client computing machines to automatically and periodically upload, over the Internet, Graphic Application Profiles (GAPs) for storage and use within the Behavorial Profile DB of the MMPGRS.

Another object of the present invention is to provide such an Internet-based central application profile database server system which, by enabling the automatic uploading of expert GAPs into the MMPGRS, graphic application users (e.g. gamers) can immediately enjoy high performance graphics on the display devices of their client machines, without having to develop a robust behavioral profile based on many hours of actual user-system interaction.

Another object of the present invention is to provide such an Internet-based central application profile database (DB) server system, wherein “expert” GAPs are automatically generated by the Central Application Profile Database (DB) Server System by analyzing the GAPs of thousands of different game application users connected to the Internet, and participating in the system.

Another object of the present invention is to provide such an Internet-based central application profile database (DB) server system, wherein for MMPGRS users subscribing to the Automatic GAP Management Services, each such MMPGRS runs an application profiling and control algorithm that uses the most recently uploaded expert GAP loaded into its profiling and control mechanism (PCM), and then allow system-user interaction, user behavior, and application performance to modify the expert GAP profile over time until the next update occurs.

Another object of the present invention is to provide such an Internet-based central application profile database (DB) server system, wherein the Application Profiling and Analysis Module in each MMGPRS subscribing to the Automatic GAP Management Services supported by the Central Application Profile Database (DB) Server System of the present invention, modifies and improves the downloaded expert GAP within particularly set limits and constraints, and according to particular criteria, so that the expert GAP is allowed to evolve in an optimal manner, without performance regression.

These and other objects of the present invention will become apparent hereinafter and in the claims to invention.

### BRIEF DESCRIPTION OF DRAWINGS OF PRESENT INVENTION

For a more complete understanding of how to practice the Objects of the Present Invention, the following Detailed Description of the Illustrative Embodiments can be read in conjunction with the accompanying Drawings, briefly described below:

FIG. 1A is a graphical representation of a typical prior art PC-based computing system employing a conventional graphics architecture driving a single external graphic card (105);

FIG. 1B a graphical representation of a conventional GPU subsystem supported on the graphics card of the PC-based graphics system of FIG. 1A;

FIG. 1C is a graphical representation of a typical prior art PC-based computing system employing a conventional graphics architecture employing a memory bridge with an integrated graphics device (IGD) (103) supporting a single graphics pipeline process;

FIG. 1D is a graphical representation illustrating the general software architecture of the prior art IGD-based computing system shown in FIG. 1C;

FIG. 1E is graphical representation of the memory bridge employed in the system of FIG. 1C, showing the micro-architecture of the IGD supporting the single graphics pipeline process;

FIG. 1F is a graphical representation of a conventional method of rendering successive 3D scenes using a single GPU graphics platform to support a single graphics pipeline process;

FIG. 2A is a graphical representation of a typical prior art PC-based computing system employing a conventional dual-GPU graphic architecture comprising two external graphic cards (i.e. primary (105) and secondary (107) graphics cards) connected to the host computer, and a display device (106) attached to the primary graphics card;

FIG. 2B is a graphical representation illustrating the general software architecture of the prior art PC-based graphics system shown in FIG. 2A;

FIG. 2C is a graphical representation of a conventional GPU subsystem supported on each of the graphics cards employed in the prior art PC-based computing system of FIG. 2A;

FIG. 2D is a graphical representation of a conventional parallel graphics rendering process being carried out according to the Time Division Method of parallelism using the dual GPUs provided on the prior art graphics platform illustrated in FIGS. 2A through 2C;

FIG. 2E. is a graphical representation of a conventional parallel graphics rendering process being carried out according to the Image Division Method of parallelism using the dual GPUs provided on the prior art graphics platform illustrated in FIGS. 2A through 2C;

FIG. 3A is a schematic representation of a prior art parallel graphics platform comprising multiple parallel graphics pipelines, each supporting video memory and a GPU, and feeding complex pixel compositing hardware for composing a final pixel-based image for display on the display device;

FIG. 3B is a graphical representation of a conventional parallel graphics rendering process being carried out according to the Object Division Method of parallelism using multiple GPUs on the prior art graphics platform of FIG. 3A;

FIG. 4A is a schematic representation of the multi-mode parallel 3D graphics rendering system (MMPGRS) of the present invention employing automatic 3D scene profiling and multiple GPU and state control, wherein the system supports three primary parallelization stages, namely, Decomposition Module (401), Distribution Module (402) and Recomposition Module (403), and wherein each stage performed by its corresponding module is configured (i.e. set up) into a sub-state by set of parameters A for 401, B for 402, and C for 403, and wherein the “Graphics Rendering Parallelism State” for the overall multi-mode parallel graphics system is established or determined by the combination of sub-states of these component stages;

FIG. 4A1 is a schematic representation for the Mode Definition Table which shows the four combinations of sub-modes A:B:C for realizing the three Parallel Modes of the parallel graphics system of the present invention, and its one Single (GPU) (Non-Parallel Functioning) Mode of the system;

FIG. 4B is a State Transition Diagram for the multi-mode parallel 3D graphics rendering system of present invention, illustrating that a parallel state is characterized by A, B, C sub-state parameters, that the non-parallel state (single GPU) is an exceptional state, reachable from any state by a graphics application or PCM requirement, and that all state transitions in the system are controlled by Profiling and Control Mechanism (PCM), wherein in those cases of known and previously analyzed graphics applications, the PCM, when triggered by events (e.g. drop of FPS), automatically consults the Behavioral Database in course of application, or otherwise, makes decisions which are supported by continuous profiling and analysis of listed parameters, and/or trial and error event driven or periodical cycles;

FIG. 4C is a schematic representation of the User Interaction Detection (UID) Subsystem employed within the Application Profiling and Analysis Module of the Profiling and Control Mechanism (PCM) in the multi-mode parallel 3D graphics rendering system (MMPGRS) of the present invention, wherein the UID Subsystem is shown comprising a Detection and Counting Module arranged in combination with a UID Transition Decision Module;

FIG. 4D is a flow chart representation of the state transition process between Object-Division/Image-Division Modes and the Time Division Mode initiated by the UID subsystem employed in the multi-mode parallel 3D graphics rendering system of the present invention;

FIG. 5A1 is a schematic representation of process carried out by the Profiling and Control Cycle in the Profiling and Control Mechanism (PCM) in the multi-mode parallel 3D graphics rendering system of present invention, while the UID Subsystem is disabled;

FIG. 5A2 is a schematic representation of process carried out by the Profiling and Control Cycle in the Profiling and Control Mechanism in the multi-mode parallel 3D graphics rendering system of present invention, while the UID Subsystem is enabled;

FIG. 5B is a schematic representation of process carried out by the Periodical Trial & Error Based Control Cycle in the Profiling and Control Mechanism employed in the multi-mode parallel 3D graphics rendering system of present invention, shown in FIG. 4A;

FIG. 5C is a schematic representation of process carried out by the Event Driven Trial & Error Control Cycle in the Profiling and Control Mechanism employed in the multi-mode parallel 3D graphics rendering system of present invention, shown in FIG. 4A;

FIG. 5D is a schematic representation illustrating the various performance and interactive device data inputs into the Application Profiling and Analysis Module within the Profiling and Control Mechanism employed in the multi-mode parallel 3D graphics rendering system of present invention shown in FIG. 4A, as well as the tasks carried out by the Application Profiling and Analysis Module;

FIG. 6A is a schematic block representation of a generalized software-based system architecture for the multi-mode parallel 3D graphics rendering system of the present invention depicted in FIG. 4A, and illustrating the Profiling and Control Mechanism (400) supervising the flexible parallel rendering structure which enables the real-time adaptive, multi-mode parallel 3D graphics rendering system of present invention;

FIG. 6A1 is a schematic representation of the generalized software-based system architecture for the multi-mode parallel 3D graphics rendering system of the present invention depicted in FIG. 6A, showing the subcomponents of each GPU and video memory in the system and the interaction with the software-implemented Decomposition, Distribution And Recomposition Modules of the present invention;

FIG. 6A2 is a flow chart illustrating the processing of a single frame of graphics data during the image division mode of parallel graphics rendering supported on the multi-mode parallel 3D graphics rendering system of the present invention depicted in FIGS. 6A and 6A1;

FIG. 6A3 is a flow chart illustrating the processing of a sequence of pipelined image frames during the time division mode of parallel graphics rendering supported on the multi-mode parallel 3D graphics rendering system of the present invention depicted in FIGS. 6A and 6A1;

FIG. 6A4 is a flow chart illustrating the processing of a single image frame during the object division mode of parallel graphics rendering supported on the multi-mode parallel 3D graphics rendering system of the present invention depicted in FIGS. 6A and 6A1;

FIG. 6B is a schematic block representation of a generalized hardware-based system architecture of the multi-mode parallel 3D graphics rendering system of the present invention depicted in FIG. 4A, and illustrating the Profiling and Control Mechanism (400) that supervising the flexible Hub-based parallel rendering structure which enables the real-time adaptive, multi-mode parallel 3D graphics rendering system of present invention;

FIG. 6B1 is a schematic representation of the generalized hardware-based system architecture of the multi-mode parallel 3D graphics rendering system of the present invention depicted in FIG. 6B, showing the subcomponents of each GPU and video memory in the system and the interaction with the software-implemented decomposition module of the present invention;

FIG. 6B2 is a flow chart illustrating the processing of a single frame of graphics data during the image division mode of parallel graphics rendering supported on the multi-mode parallel 3D graphics rendering system of the present invention depicted in FIGS. 6B and 6B1;

FIG. 6B3 is a flow chart illustrating the processing of a sequence of pipelined frames of graphics data during the time division mode of parallel graphics rendering supported on the multi-mode parallel 3D graphics rendering system of the present invention depicted in FIGS. 6B and 6B1;

FIG. 6B4 is a flow chart illustrating the processing of a single frame of graphics data during the object division mode of parallel graphics rendering supported on the multi-mode parallel 3D graphics rendering system of the present invention depicted in FIGS. 6B and 6B1;

FIG. 7A is a schematic block representation of an illustrative design for the multi-mode parallel 3D graphics rendering system of present invention (700), having a software-based system architecture employing two GPUs and a software package (701) comprising the Profiling and Control Mechanism (400) and a suit of three parallelism driving the software-based Decomposition Module (401′), Distribution Module (402′) and Recomposition Module (403′);

FIG. 7B is a schematic block representation of an illustrative design for the multi-mode parallel 3D graphics rendering system of present invention (710), having a hardware-based system architecture employing a Graphic Hub (comprising Distribution Module 402″ and Recomposer Module 403″) for parallelizing the operation of multiple GPUs, and a software components comprising the Profiling and Control Mechanism (400) and Decomposition Module (401) realized in the host (CPU) memory space;

FIG. 7C is a schematic block representation of an illustrative design for the multi-mode parallel graphics rendering system of present invention, having a hardware-based system architecture implemented with an IGD of the present invention (on a chipset level), and employing multiple GPUs capable of parallelizing graphics rendering operation according to the principles of the present invention;

FIG. 7D is a schematic block representation of an illustrative design for the multi-mode parallel 3D graphics rendering system of present invention, having a hardware-based system, architecture implemented with an IGD of the present invention (on a chipset level) employing a single GPU, capable of parallel operation in conjunction with one or more GPUs supported on an external graphic card;

FIG. 7E is a schematic block representation of an illustrative design for the multi-mode parallel 3D graphics rendering system of present invention, having a software-based system architecture capable of parallelizing the operation of a GPU integrated on an IGD chipset and one or more GPUs supported on one or more external graphic cards;

FIG. 7F is a schematic block representation of an illustrative design for the multi-mode parallel 3D graphics rendering system of present invention, having a hardware-based system architecture implemented using an IGD of the present invention (on a chipset level) capable of controlling a single integrated GPU, or parallelizing the GPUs on a cluster of external graphic cards;

FIG. 8A is a schematic block representation of an illustrative implementation of a hardware-based design for the multi-mode parallel graphics rendering system of the present invention present invention, using multiple discrete graphic cards and hardware-based distribution and recomposition modules or components (402″ and 403″) realized on a hardware-based graphics hub of the present invention, as shown in FIG. 7B;

FIG. 8B is a schematic representation of a first illustrative hardware-based embodiment of the multi-mode parallel graphics rendering system of FIG. 8A, wherein the hardware-based distribution and recomposition modules (402″ and 403″) associated with the hardware-based hub of the present invention are realized as a chip or chipset on a discrete interface board (811), that is interfaced with the CPU motherboard (814), along with multiple discrete graphics cards (813 and 814), supporting multiple GPUs, are interfaced using a PCIexpress or like interface;

FIG. 8C is a schematic representation of a second illustrative hardware-based embodiment of the multi-mode parallel graphics rendering system of FIG. 8A, wherein the hardware-based distribution and recomposition modules (402″ and 403″) associated with the hardware-based graphics hub of the present invention are realized as a chip or chipset on a board attached to an external box (821), to which multiple discrete graphics cards (813), supporting multiple GPUs, are interfaced using a PCIexpress or like interface;

FIG. 8D is a schematic representation of a third illustrative hardware-based embodiment of the multi-mode parallel graphics rendering system of FIG. 8A, wherein the hardware-based distribution and recomposition modules (402″ and 403″) associated with the hardware-based graphics hub of the present invention are realized in a chip or chipset on the CPU motherboard (831), to which multiple discrete graphics cards (832), supporting multiple GPUs, are interfaced using a PCIexpress or like interface;

FIG. 8E is a schematic block representation of an illustrative embodiment of a software-based implementation of the multi-mode parallel graphics rendering system of the present invention, using multiple discrete GPUs, and software-based decomposition, distribution and recomposition modules (701) implemented within host memory space of the host computing system, as illustrated in FIG. 7A;

FIG. 8F is a schematic representation of a first illustrative embodiment of a software-based implementation of the multi-mode parallel graphics rendering system of FIG. 8E, wherein discrete dual (or multiple) graphics cards (each supporting a single GPU) are interfaced with the CPU motherboard by way of a PCIexpress or like interface, as illustrated in FIG. 7A;

FIG. 8G is a schematic representation of a second illustrative embodiment of a software-based implementation of the multi-mode parallel graphics rendering system of FIG. 8E, wherein multiple GPUs are realized on a single graphics card which is interface to the CPU motherboard by way of a PCIexpress or like interface;

FIG. 8H is a schematic representation of a third illustrative embodiment of a software-based implementation of the multi-mode parallel graphics rendering system of FIG. 8E, wherein multiple discrete graphics cards (each having a single GPU) are interfaced with a board within an external box that is interface to the motherboard within the host computing system;

FIG. 9A is a schematic block representation of a generalized hardware implementation of the multi-mode parallel graphics rendering system of the present invention, wherein multiple GPUs (715) and hardware-based distribution and recomposition (hub) components (402″ and 403″) the present invention are implemented on a single graphics display card (902), and to which the display device is attached, as illustrated in FIG. 7B;

FIG. 9B is a schematic representation of an illustrative embodiment of the multi-mode parallel graphics rendering system of FIG. 9A, wherein multiple GPUs (715) and hardware-based distribution and recomposition (hub) components (402″ and 403″) of the present invention are implemented on a single graphics display card (902), which is interfaced to the motherboard within the host computing system, and to which the display device is attached, as shown in FIG. 7B;

FIG. 10A is a schematic block representation of a generalized hardware implementation of the multi-mode parallel graphics rendering system of the present invention realized using system on chip (SOC) technology, wherein multiple GPUs and the hardware-based distribution and recomposition modules are implemented in a single SOC-based graphics chip (1001) mounted on a single graphics card (1002), while the software-based decomposition module is implemented in host memory space of the host computing system;

FIG. 10B is a schematic representation of an illustrative embodiment of a SOC implementation of the multi-mode parallel graphics rendering system of FIG. 10A, wherein multiple GPUs and hardware distribution and recomposition components are realized on a single SOC implementation of the present invention (1001) on a single graphics card (1002), while the software-based decomposition module is implemented in host memory space of the host computing system;

FIG. 10C is a schematic block representation of an illustrative embodiment of the multi-mode parallel graphics rendering system of the present invention, wherein a multiple GPU chip is installed on a single graphics display card which is interfaced to the motherboard of the host computing system by way of a PCIexpress or like bus, and wherein the software-based decomposition, distribution, and recomposition modules of the present invention are implemented within the host memory space of the computing system, and wherein a display device is attached to the single graphics card, as illustrated in FIG. 7A;

FIG. 10D is schematic illustration of the multi-mode parallel graphics rendering system of FIG. 10C, employing a multiple GPU chip installed on a single graphics display card which is interfaced to the motherboard of the host computing system by way of a PCIexpress or like bus, and the software-based decomposition, distribution, and recomposition modules of the present invention are implemented within the host memory space of the computing system;

FIG. 11A is a schematic block representation of an illustrative embodiment of the multi-mode parallel graphics rendering system of FIGS. 7C, 7D and 7F, wherein (i) an integrated graphics device (IGD, 1101) supporting the hardware-based distribution and recomposition modules of present invention is implemented within the memory bridge (1101) chip on the motherboard of the host computing system, (ii) the software-based decomposition and distribution modules of the present invention are realized within the host memory space of the host computing system, and (iii) multiple graphics display cards (717) are interfaced to the IDG by way of a PCIexpress or like interface, and to which the display device is attached;

FIG. 11A1 is a schematic representation of a first illustrative embodiment of the multi-mode parallel graphics rendering system of FIG. 11A, wherein (i) the integrated graphics device (IGD 1112) is realized within the memory bridge (1111) on the motherboard of the host computing system, (ii) the software-based decomposition module of the present invention is realized within the host (CPU) memory space of the computing system, and (iii) multiple graphics display cards (717) (supporting multiple GPUs) are interfaced to a board within an external box, which is interface to the IDG by way of a PCIexpress or like interface, and to which the display device is connected;

FIG. 11A2 is a schematic representation of a second illustrative embodiment of the multi-mode parallel graphics rendering system of FIG. 11A, wherein (i) the integrated graphics device (IGD 1112) is realized within the memory bridge (1111) on the motherboard of the host computing system, (ii) the software-based decomposition module of the present invention is realized within the host memory space of the host computing system, and (iii) multiple graphics display cards (717) each with a single GPU are interface to the IDG by way of a PCIexpress or like interface, and to which the display device is attached;

FIG. 11A3 is a schematic representation of a third illustrative embodiment of the multi-mode parallel graphics rendering system of FIG. 11A, wherein (i) the integrated graphics device (IGD 1112) is realized within the memory bridge (1111) on the motherboard of the host computing system, (ii) the software-based decomposition module of the present invention is realized within the host memory space of the host computing system, and (iii) multiple GPUs on a single graphics display card (717) are connected to the IDG by way of a PCIexpress or like interface, and to which the display device is attached;

FIG. 11B is a schematic block representation of an illustrative embodiment of the multi-mode parallel graphics rendering system of FIG. 7E, wherein (i) a prior art (conventional) integrated graphics device (IGD) is implemented within the memory bridge (1101) chip on the motherboard of the host computing system, (ii) the software-based decomposition, distribution and recomposition modules of the present invention (701) are realized within the host memory space of the host computing system, and (iii) multiple GPUs (1120) are interfaced to the conventional IDG by way of a PCIexpress or like interface, and to which the display device is attached;

FIG. 11B1 is a schematic representation of a first illustrative embodiment of the multi-mode parallel graphics rendering system of FIG. 11B, wherein (i) the conventional IGD is realized within the memory bridge on the motherboard of the host computing system, (ii) the software-based decomposition, distribution and recomposition modules of the present invention (701) are realized within the host (CPU) memory space of the computing system, and (iii) multiple graphics display cards (each supporting a single GPU) are interfaced to the motherboard of the host computing system by way of a PCIexpress or like interface, and to which the display device is connected;

FIG. 11B2 is a schematic representation of a second illustrative embodiment of the multi-mode parallel graphics rendering system of FIG. 11B, wherein (i) the conventional IGD is realized within the memory bridge on the motherboard of the host computing system, (ii) the software-based decomposition, distribution and recomposition modules of the present invention (701) are realized within the host (CPU) memory space of the computing system, and (iii) a single graphics display card (supporting multiple GPUs) is interfaced to the motherboard of the host computing system by way of a PCIexpress or like interface, and to which the display device is connected;

FIG. 12A is a schematic representation of a multi-user computer network supporting a plurality of client machines, wherein one or more client machines (i) employ the MMPGRS of the present invention designed using the software-based system architecture of FIG. 7A and (ii) respond to user-system interaction input data streams from one or more network users who might be local each other as over a LAN, or be remote to each other as over a WAN or the Internet infrastructure; and

FIG. 12B is a schematic representation of a multi-user computer network supporting a plurality of client machines, wherein one or more client machines (i) employ the MMPGRS of the present invention designed using the hardware-based system architecture of FIG. 7B, and (ii) respond to user-system interaction input data streams from one or more network users who might be local each other as over a LAN, or be remote to each other as over a WAN or the Internet infrastructure.

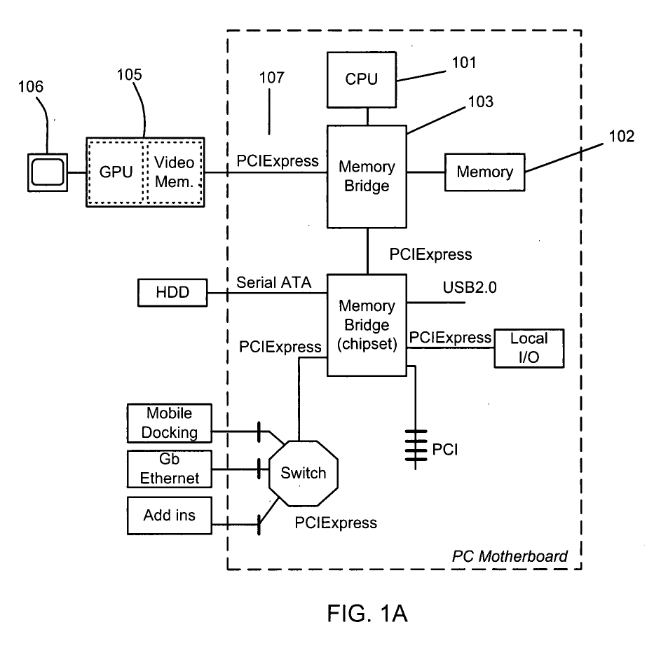

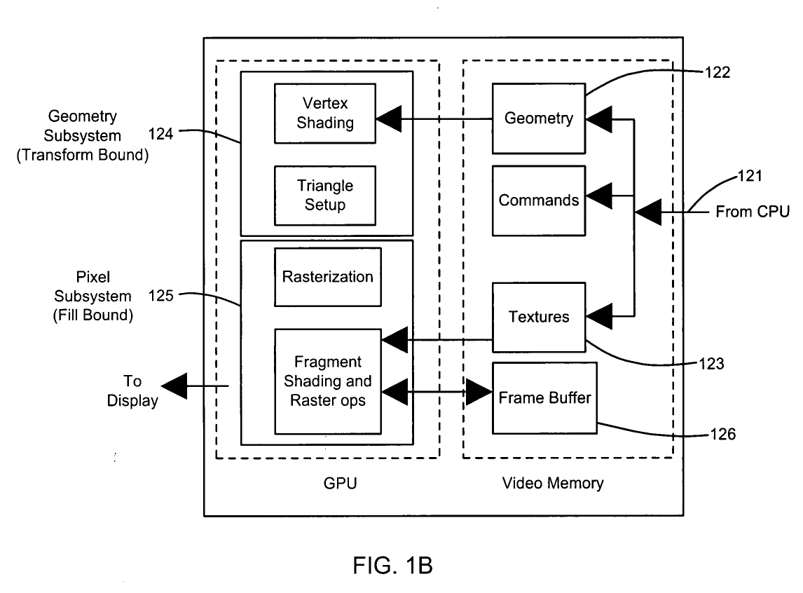

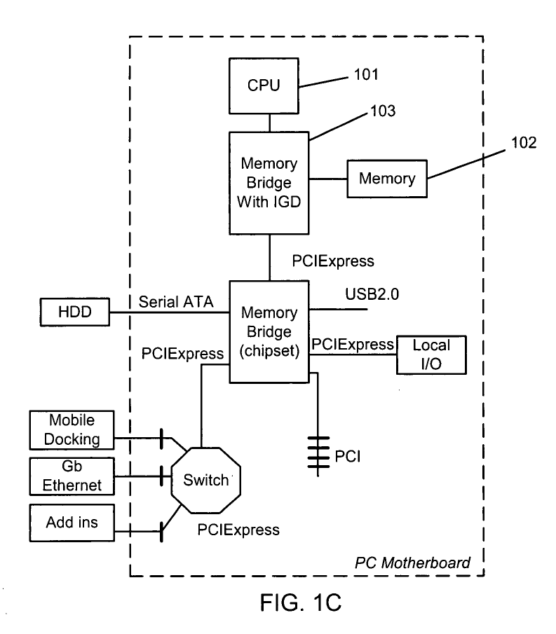

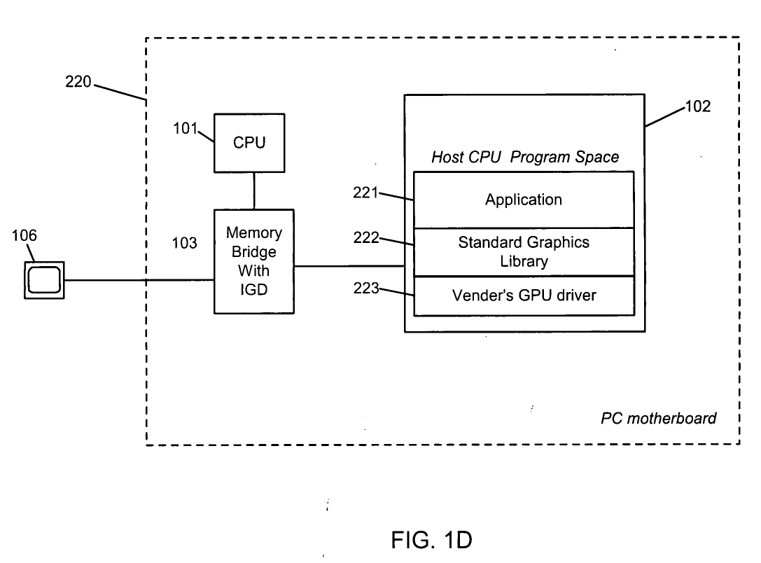

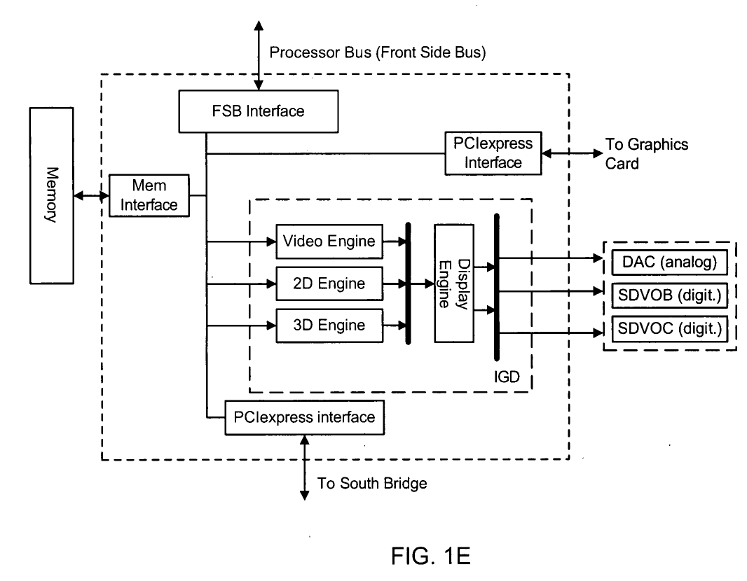

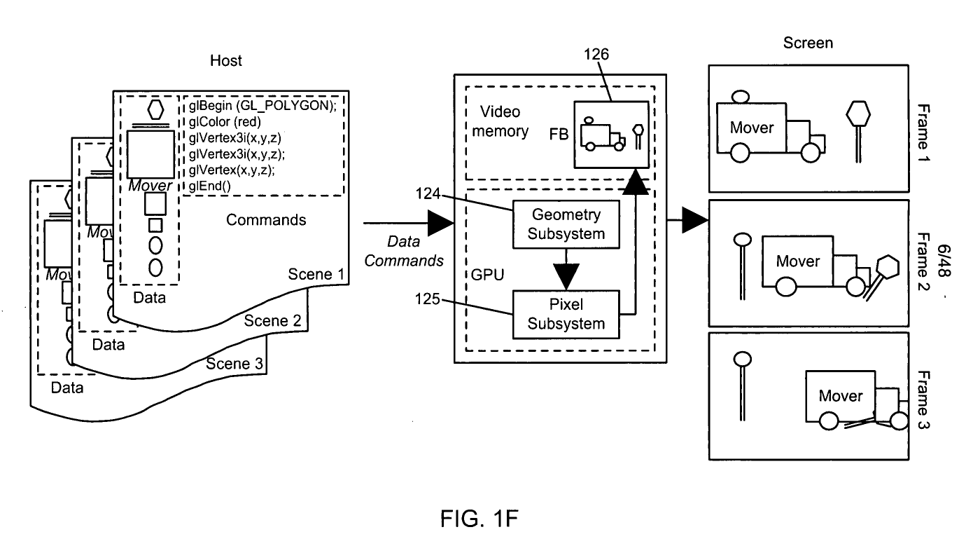

### DETAILED DESCRIPTION OF THE ILLUSTRATIVE EMBODIMENTS OF THE PRESENT INVENTION

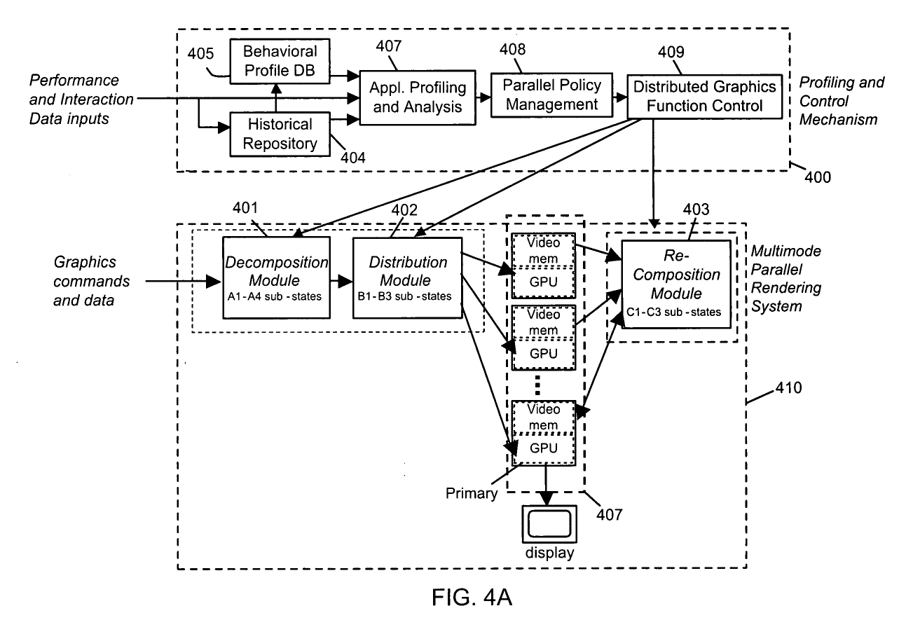

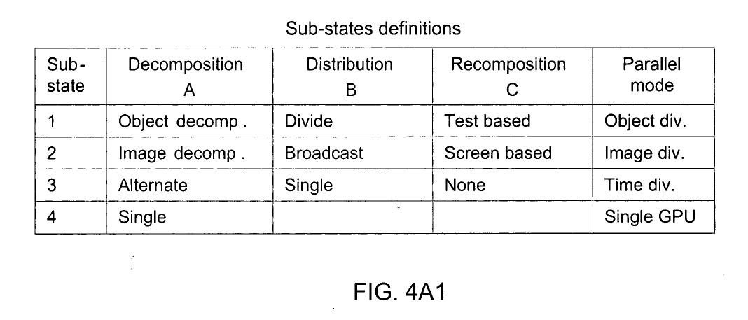

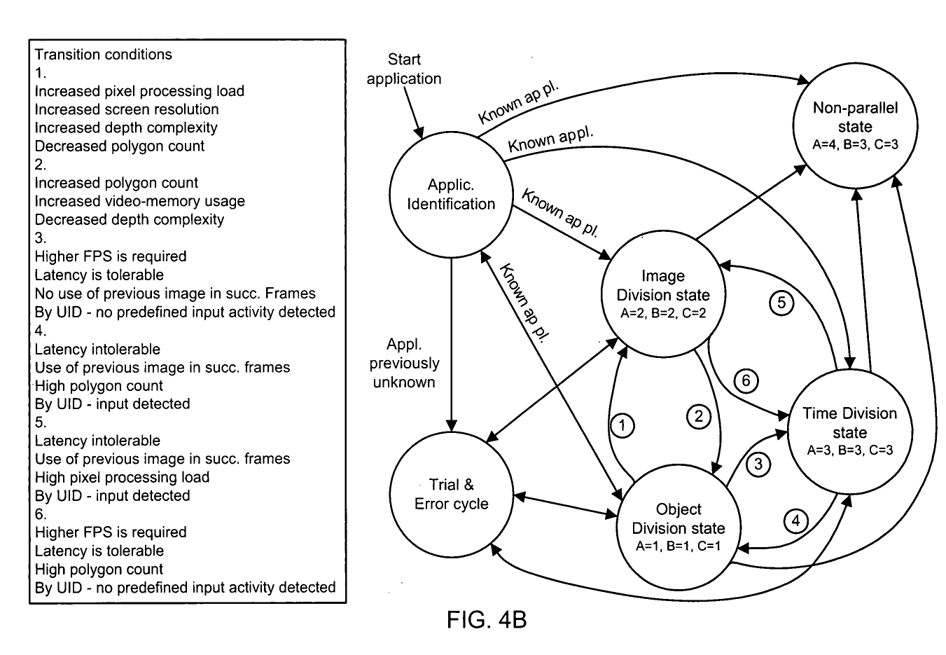

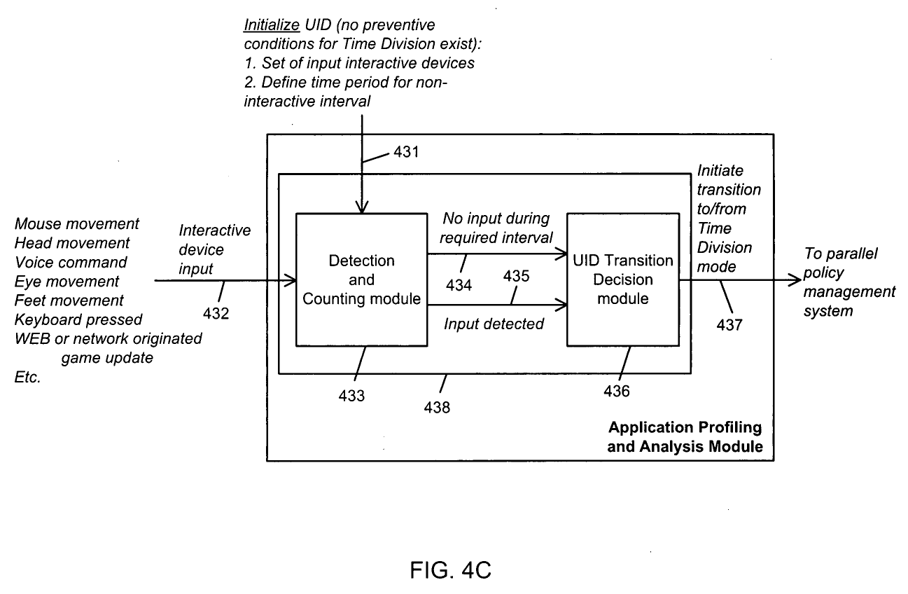

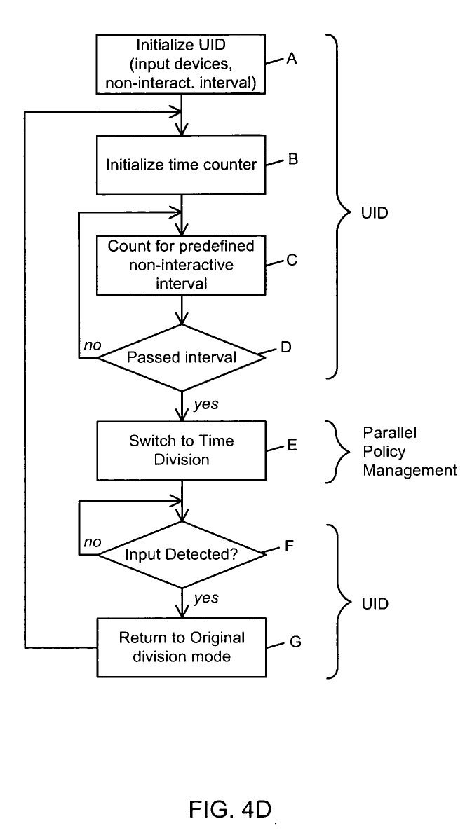

Referring to the FIG. 4A through 11B in the accompanying Drawings, the various illustrative embodiments of the multiple-mode multiple GPU-based parallel graphics rendering system and process of the present invention will now be described in great detail, wherein like elements will be indicated using like reference numerals.

In general, one aspect of the present invention teaches how to dynamically retain high and steady performance of a three-dimensional (3D) graphics system on conventional platforms (e.g. PCs, laptops, servers, etc.), as well as on silicon level graphics systems (e.g. graphics system on chip (SOC), and integrated graphics device IGD implementations). This aspect of the present invention is accomplished by means of novel architecture of adaptive graphics parallelism having both software and hardware embodiments.

The multiple-mode multiple GPU-based parallel graphics rendering system fulfills the great need of the marketplace by providing a highly-suited parallelism scheme, wherein different GPU-parallel rendering schemes dynamically, alternate throughout the course of any particular graphics application, and adapting the optimal parallel rendering method (e.g. Image, Time or Frame Division Method) in real-time to meet the changing needs of the graphics application.

### Multi-mode Parallel Graphics Rendering System Employing Automatic Profiling and Control

FIG. 4A shows the Multi-Mode Parallel Graphics Rendering System (MMPGRS) of present invention employing automatic 3D scene profiling and multiple GPU control. The System comprises:
(i) Multi-Mode Parallel Graphics Rendering Subsystem (420) including three parallelization stages realized by a Decomposition Module (401), Distribution Module (402) and Recomposition Module (403), and an array of Graphic Processing Units (GPUs) (407); and
(ii) Profiling and Control Mechanism (PCM) (400).

### Multi-Mode Parallel Graphics Rendering Subsystem

In the Multi-Mode Parallel Graphics Rendering Subsystem (420), each stage is induced (i.e. set up) into a sub-state by a set of parameters; A for 401, B for 402, and C for 403. The state of parallelism of the overall graphic system is established by the combination of sub-states A, B and C, as listed in the Mode/State Definition Table of FIG. 4A1, which will be elaborated hereinafter.

The unique flexibility of the Multi-Mode Parallel Graphics Rendering Subsystem stems from its ability to quickly change its sub-states, resulting in transition of the overall graphic system to another parallel State, namely: the Object Division State, the Image Division State or the Time Division State, as well as to other potential parallelization schemes that may be programmed into the MMPGRS of the present invention.

The array of GPUs (407) comprises N pairs of GPU and Video Memory pipelines, while only one of them, termed “primary,” is responsible for driving the display unit (e.g. LCD panel, LCD or DLP Image/Video “Multi-Media” Projector, and the like). Each one of the staging blocks (i.e. Decomposition Module (401), Distribution Module (402) and Recomposition Module (403), carries out all functions required by the different parallelization schemes supported on the multi-mode parallel graphics rendering system platform of the present invention.

The primary function of the Decomposition Module (401) is to divide (i.e. split up) the stream of graphic data and commands according to the required parallelization mode, operative at any instant in time. In general, the typical graphics pipeline is fed by stream of commands and data from the application and graphics library (OpenGL or Direct 3D). This stream, which is sequential in nature, has to be properly handled and eventually partitioned, according to parallelization mode (i.e. method) used. The Decomposition Module can be set to different decomposing sub-states (A1 through A4), according to FIG. 4A1, namely: Object Decomposition for the Object Division State; Image Decomposition for the Image Division State; Alternate Decomposition for the Time Division State; and Single for the Single GPU (Non-Parallel), State. Each one of these parallelization states will be described in great technical detail below.

The primary function of the Distribution Module (402) is to physically distribute the streams of graphics data and commands to the cluster of GPUs supported on the MMPGRS platform. The Distribution Module is set to the B1 sub-state (i.e. the Divide Sub-state) during the Object Division State; the B2 Sub-state (i.e. the Broadcast Sub-state) during the Image Division State; and the B3 Sub-state (i.e. Single GPU Sub-state) during the Time Division and Single GPU (i.e. Non-Parallel system) States.

The primary function of the Recomposition Module (403) is to merge together, the partial results of multiple graphics pipelines, according to parallelization mode, operative at any instant in time. The resulting final Frame Buffer (FB) is sent into the display device (via primary GPU, or directly). This Module has three (C1 through C3) sub-states. The Test based sub-state carries out re-composition based on test performed on partial frame buffer pixels; typically these are depth test, stencil test, or combination thereof. The Screen based sub-state combines together parts of the final frame buffers, in a puzzle like fashion, creating a single image. The None mode makes no merges, just moves one of the pipeline frame buffers to the display, as required in time division parallelism or in single GPU (Non-Parallel).

The combination of all Sub-States creates the various parallelization schemes supported on the MMPGRS of the present invention. The parallelization schemes of the Multi-Mode Parallel Graphics Rendering System (MMPGRS) of the present invention matches these subsystems as defined in the Table of FIG. 4A1.

### Image Division State of Operation:

In the Image Division State of Operation, the Decomposition Module is set to the Image Decomposition Sub-mode (A=2), multiplicating the same command and data stream to all GPUs, and defining unique screen portion for each one, according to the specific Image Division Mode in use (e.g. split screen, or tiled screen). The Distribution Module is set in Broadcast Sub-mode B=2, to physically broadcast the stream to all GPUs. Finally the Recomposition Module I set to Screen-based Sub-mode C=2, and collects all the partial images into final frame buffer, performing the screen based composition.

### Time Division State of Operation:

In the Time Division State of Operation, each GPU renders the next successive frame. The Decomposition Module is set to the Alternate Sub-mode, A=3, alternating the command and data stream among GPUs on frame basis. The Distribution Module is set to the Single Sub-mode, B=3, physically moving the stream to the designated GPU. Finally the Recomposition Module is set to None, C=3, as no merge is needed and the frame buffer is just moved from the designated GPU to the screen for display.

### Object Division State of Operation:

In the Object Division State of operation, the Decomposition Module is set to the Object Decomposition Sub-mode, A=1, decomposing the command and data stream, and targeting partial streams to different GPUs. The Distribution Module is set to the Divide Sub-mode, B=1, physically delivering the partial commands and data to GPUs. Finally the Recomposition Module is set to Test-Based Sub-mode, C=1, compositing the frame buffer color components of GPUs, based on depth and/or stencil tests.

### Single GPU State of Operation:

While the Single GPU State of Operation is a non-parallel state of operation, it is allowed and supported in the system of the present invention as this state of operation is beneficial in some exceptional cases. In the Single GPU State, the Decomposition, Distribution, and Recomposition Modules are set on Single (A=4), Single (B=3) and None (C=3), respectively. Only one GPU, of all pipelines, is used in the single case.

### Description of the Profiling and Control Mechanism (PCM) 400 Within the MMPGRS of the Present Invention

As shown in FIG. 4A, the Profiling and Control Mechanism (PCM) 400 comprises three algorithmic modules, namely: an Application Profiling and Analysis Module (407); Parallel Policy Management Module (408) and Distributed Graphics Function Control. The Profiling and Control Mechanism (PCM) also comprises two data stores: the Historical Repository (404); and the Behavioral Profile DB (405). The primary function of the PCM is to control the state of Multi-mode Parallel Rendering Subsystem (410) by virtue of this subsystem flexible multi-state behavior and fast interstate transitions

As shown in FIG. 4C, the Profiling and Control Mechanism (PCM) 400 comprises a User Interaction Detection (UID) Subsystem 438 which includes a Detection and Counting Module 433 in combination with a UID Transition Decision Module 436. These subsystems and modules will be described in greater detail hereinbelow.

### State Transitions Within the MMPGRS of the Present Invention

As shown in the state transition diagram of FIG. 4B, the MMPGRS of the illustrative embodiment has six system states. Three of these system states are parallel graphics rendering states, namely: the Image Division State, which is attained when the MMPGRS is operating in its Image Division Mode; the Object Division State, which is attained when the MMPGRS is operating in its Object Division Mode; and the Time Division State, which is attained when the MMPGRS is operating in its Time Division Mode. The system also includes a Non-Parallel Graphics Rendering State, which is attained only when a single GPU and graphics pipeline are operational during the graphics rendering process. There is also an Application Identification State, and a Trial & Error Cycle State. As shown, each parallelization state is characterized by sub-state parameters A, B, C. As shown in the state transition diagram of FIG. 4B, the Non-Parallel State is reachable from any other state of system operation.

In accordance with the principles of the present invention, profiles of all previously analyzed and known graphics-based Applications are stored in the Behavioral Profile DB (405) of the MMPGRS. When the graphics-based Application starts, the system enters Application Identification State, and the PCM attempts to automatically identify whether this application is previously known to the system. In the case of a previously known application, the optimal starting state is recommended by the DB, and the system transitions to that system state. Further on, during the course of the Application, the PCM is assisted by the Behavioral Database to optimize the inter-state tracking process within the MMPGRS. In the case of an Application previously unknown to the MMPGRS, the Trial & Error Cycle State is entered, and attempts to run all three parallelization schemes (i.e. Modes) are made for a limited number of cycles.

During the course of the Application, the decision by the system as to which mode of graphics rendering parallelization to employ (at any instant in time) is supported either by continuous profiling and analysis, and/or by trial and error. The Trial and Error Process is based on comparing the results of a single, or very few cycles spent by the system at each parallelization state.

During the course of continuous profiling and analysis by the Application Profiling and Analysis Module (407), the following parameters are considered by the PCM with respect to a state/mode transition decision:

(1) Pixel processing load

(2) Screen resolution

(3) Depth complexity of the scene

(4) Polygon count

(5) Video-memory usage

(6) Frame/second rate

(7) Change of frames/second rate

(8) Tolerance of latency

(9) Use of the same FB in successive frame

(10) User-System Interaction during the running of the Application.

User-Interactivity Driven Mode Selection within the MMPGRS of the Present Invention

Purely in terms of “frames/second” rate, the Time Division Mode is the fastest among the parallel graphics rendering modes, and this is by virtue of the fact that the Time Division Mode works favorably to reduce geometry and fragment bottlenecks by allowing more time. However, the Time Division Mode (i.e. Method) does not solve video memory bottlenecks. Also, the Time Division Mode suffers from other severe problems: (i) CPU bottlenecks; (ii) the unavailability of GPU-generated frame buffers to each other, in cases where the previous frame is required as a start point for the successive frame; and also (iii) from pipeline latency. Transition of the MMGPRS to its Object-Division Mode effectively releases the system from transform and video memory loads.

In many applications, these problems are reasons not to use the Time Division Mode. However, for some other applications, the Time Division Mode may be suitable and perform better than other parallelization schemes available on the MMGPRS of the present invention (e.g. Object-Division Mode and Image-Division Mode).

During the Time Division Mode, the pipeline latency problem arises only when user-system interaction occurs. Also, in many interactive gaming applications (e.g. video games), often there are scenes with intervals of user-system interactivity during the Time Division Mode. Thus, in order to achieve the highest performance mode of parallel graphics rendering at runtime, the MMPGRS of the present invention employs a User Interaction Detection (UID) Subsystem 438 which enables automatic and dynamic detection of the user's interaction with the system. Absent preventive conditions (such as CPU bottlenecks and need for the same FB in successive frames), this subsystem 438 enables timely implementation of the Time Division Mode only when no user-system interactivity is detected so that system performance is automatically optimized.

These and other constraints are taken into account in the inter-modal transition process, as illustrated in the State Transition Diagram of FIG. 4B, and described below:
(1) Transition from Object Division to Image Division follows a combination of one or more of the following conditions:
   a. Increase in pixel processing load
   b. Increase in screen resolution
   c. Increase in scene depth complexity
   d. Decrease in polygon count
(2) Transition from Image Division to Object Division follows a combination of one or more of the following conditions:
   a. Increase of polygon count
   b. Increase of video memory footprint
   c. Decrease of scene depth complexity
(3) Transition from Object Division to Time Division follows a combination of one or more of the following conditions:
   a. Demand for higher frame/second rate
   b. Higher latency is tolerated
   c. There is no use of the FB for successive frame
   d. No predefined input activity detected by the UID Subsystem
(4) Transition from Time Division to Object Division follows a combination of one or more of the following conditions:
   a. Latency is not tolerable
   b. FB is used for successive frame
   c. High polygon count
   d. Input activity detected by the UID Subsystem
(5) Transition from Time Division to Image Division follows a combination of one or more of the following conditions:
   a. Latency is not tolerable
   b. FB is used for successive frame
   c. High pixel processing load
   d. Input activity detected by the UID Subsystem
(6) Transition from Image Division to Time Division follows a combination of one or more of the following conditions:
   a. Demand for higher frame/second rate
   b. Latency is tolerable
   c. High polygon count
   d. No predefined input activity detected by the UID Subsystem

In the illustrative embodiment, this capacity of the MMPGRS is realized by the User Interaction Detection (UID) Subsystem 438 provided within the Application Profiling and Analysis Module 407 in the Profiling and Control Mechanism of the system. As shown in FIG. 4C, the UID subsystem 438 comprises: a Detection and Counting Module 433 in combination with a UID Transition Decision Module 436.

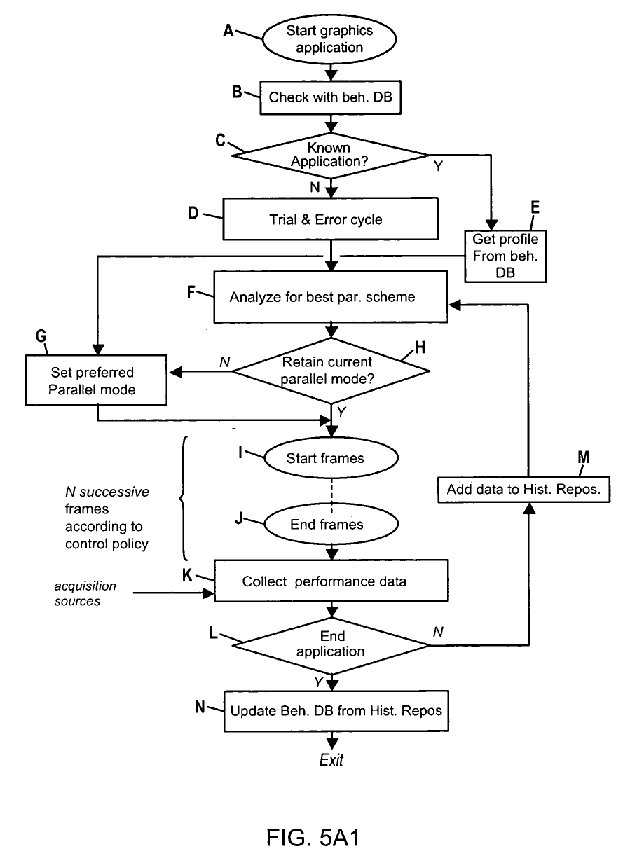

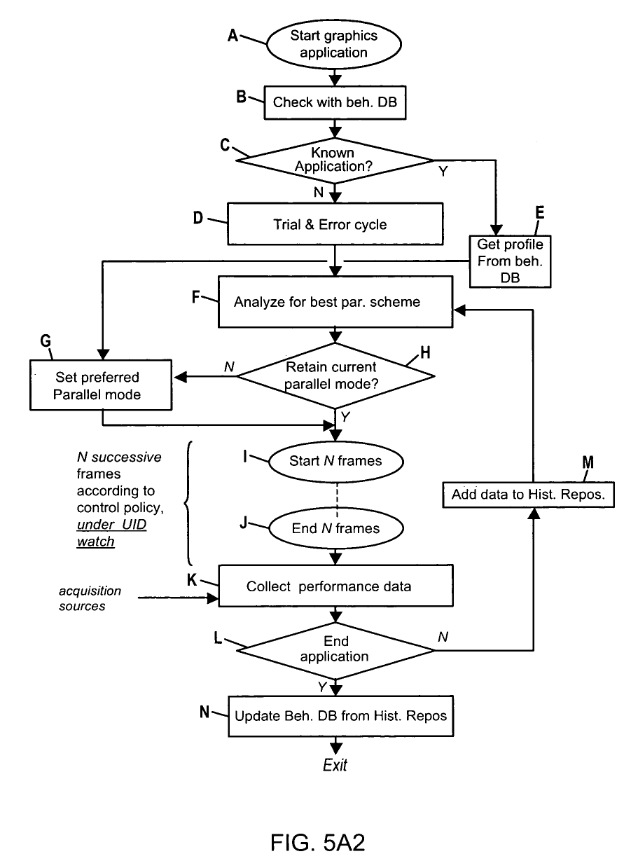

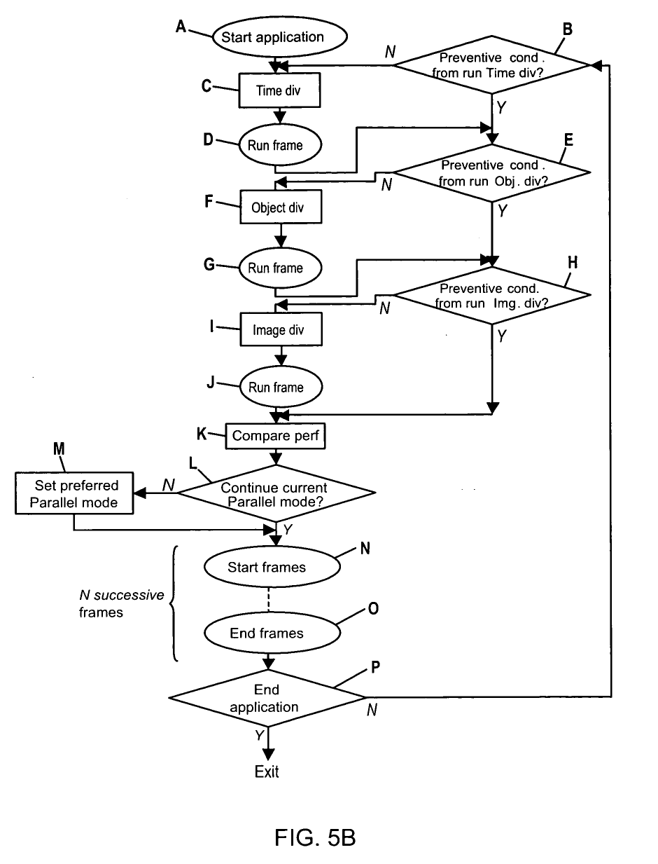

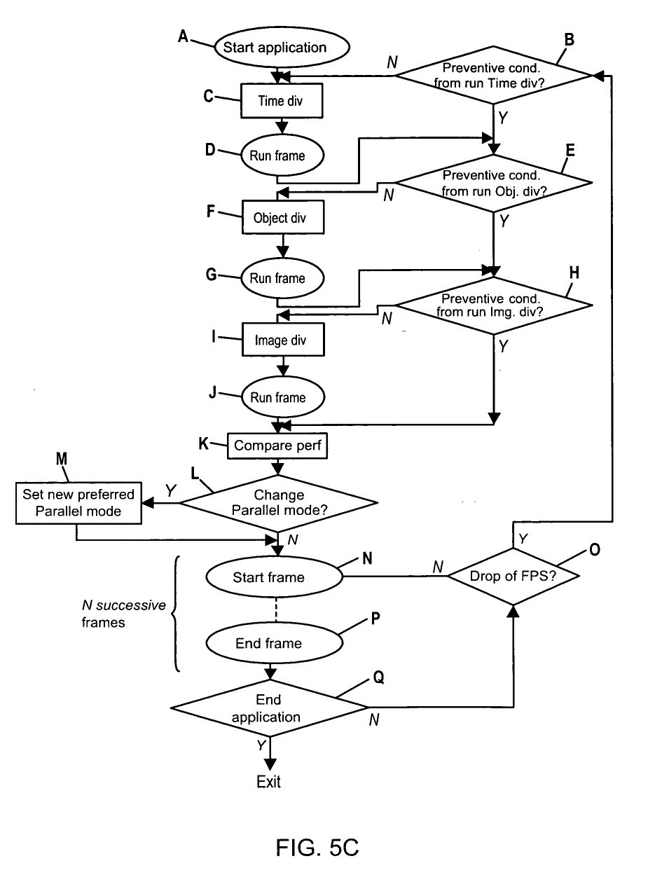

As shown in FIGS. 4C and 5D, the set of interactive devices which can supply User Interactive Data to the UID subsystem can include, for example, a computer mouse, a keyboard, eye-movement trackers, head-movement trackers, feet-movement trackers, voice command subsystems, Internet, LAN, WAN and/or Internet originated user-interaction or game updates, and any other means of user interaction detection, and the like.

As shown, each interactive device input (432) supported by the computing system employing the MMPGRS feeds User Interaction Data to the Detection and Counting Module (433) which automatically counts the elapsed passage of time for the required non-interactive interval. When such a time interval is counted or has elapsed (i.e. without detection of user-system interactivity), the Detection and Counting Module automatically generates a signal indicative of this non-interactivity (434) which is transmitted to the UID Transition Decision Module (436). Thereafter, UID Transition Decision Module (436) issues a state transition command (i.e. signal) to the Parallel Policy Management Module (408), thereby causing the MMPGRS to automatically switch from its currently running parallel mode of graphics rendering operation, to its Time Division Mode of operation. During the newly initiated Time Division Mode, whenever system-user interactivity from the interactive device is detected (432) by the Detection and Counting Module (433), an system-user interactivity signal (435) is transferred to the UID Transition Decision Module (436), thereby initiating the system to return from the then currently Time Division Mode, to its original parallel mode of operation (i.e. the Image or Object Division Mode, as the case may be).

As shown in FIG. 4C, an Initialization Signal 431 is provided to the Detection and Counting Module 433 when no preventive conditions for Time Division exist. The function of the Initialization Signal 431 is to (1) define the set of input (interactive) devices supplying interactive inputs, as well as (2) define the minimum elapsed time period with no interactive activity required for transition to the Time Division Mode (termed non-interactive interval). The function of the UID Transition Decision Module 436 is to receive detected inputs 435 and no inputs 434 during the required interval, and, produce and provide as output, a signal to the Parallel Policy Management System, initiating a transition to or from the Time Division Mode of system operation, as shown.

In applications dominated by Image Division or Object Division Modes of operation, with intervals of non-interactivity, the UID Subsystem 438 within the MMGPRS can automatically initiate a transition into its Time Division Mode upon detection of user-interactivity, without the system experiencing user lag. Then as soon as the user is interacting with the application, the UID subsystem of the MMGPRS can automatically transition (i.e. switch) the system back into its dominating mode (i.e. the Image Division or Object Division). The benefits of this method of automatic “user-interaction detection (UID)” driven mode control embodied within the MMGRPS of the present invention are numerous, including: best performance; no user-lag; and ease of implementation.

Notably, the automated event detection functions described above can be performed using any of the following techniques: (i) detecting whether or not a mouse movement or keyboard depression has occurred within a particular time interval (i.e. a strong criterion); (ii) detecting whether or not the application (i.e. game) is checking for such events (i.e. a more subtle criterion); or (iii) allowing the application's game engine itself to directly generate a signal indicating that it is entering an interactive mode.

The state transition process between Object-Division/Image-Division Modes and the Time Division Mode initiated the UID subsystem of the present invention is described in the flow-chart shown in FIG. 4D. As shown, at Block A, the UID subsystem is initialized. At Block B, the time counter of the Detection and Counting Module (433) is initialized. At Block C, the UID subsystem counts for the predefined non-interactive interval, and the result is repeatedly tested at Block D. When the test is positively passed, the parallel mode is switched to the Time-Division at Block E by the Parallel Policy Management Module. At Block F, the UID subsystem determines whether user interactive input (interactivity) has been detected, and when interactive input has been detected, the UID subsystem automatically returns the MMPGRS to its original Image or Object Division Mode of operation, at Block G.

During Blocks I and J of FIGS. 5A1 and 5A2, the entire process of User-Interactivity-Driven Mode Selection occurs within the MMPGRS of the present invention, when N successive frames according control policy are run in either the Object Division or Image Division Mode of operation.

Operation of the Profiling and Control Cycle Process within the MMPGRS of the Present Invention

Referring to FIG. 5A1, the Profiling and Control Cycle Process within the MMPGRS will now be described in detail, wherein each state transition is based on above listed parameters (i.e. events or conditions) (1) through (6) listed above, and the UID Subsystem is disabled. In this process, Steps A through C test whether the graphics application is listed in the Behavioral DB of the MMPGRS. If the application is listed in the Behavioral DB, then the application's profile is taken from the DB at Step E, and a preferred state is set at Step G. During Steps I-J, N successive frames are rendered according to Control Policy, under the control of the PCM with its UID Subsystem disabled. At Step K, Performance Data is collected, and at Step M, the collected Performance Data is added to the Historical Repository, and then analyzed for next optimal parallel graphics rendering state at Step F. Upon conclusion of application, at Step L, the Behavioral DB is updated at Step N using Performance Data collected from Historical Repository.

Referring to FIG. 5A2, the Profiling and Control Cycle Process within the MMPGRS will now be described in detail, with the UID Subsystem is enabled. In this process, Steps A through C test whether the graphics application is listed in the Behavioral DB of the MMPGRS. If the application is listed in the Behavioral DB, then the application's profile is taken from the DB at Step E, and a preferred state is set at Step G. During Steps I-J, N successive frames are rendered according to Control Policy under the control of the PCM with its UID Subsystem enabled and playing an active role in Parallel Graphics Rendering State transition within the MMPGRS. At Step K, Performance Data is collected, and at Step M, the collected Performance Data is added to the Historical Repository, and then analyzed for next optimal parallel graphics rendering state at Step F. Upon conclusion of application, at Step L, the Behavioral DB is updated at Step N using Performance Data collected from Historical Repository.

### Operation of the Periodical Trial & Error Process of the Present Invention Within the MMPGRS of the Present Invention

As depicted in FIG. 5B, the Periodical Trial & Error Process differs from the Profiling and Control Cycle Process/Method described above, based on its empirical approach. According the Periodical Trial & Error Process, the best parallelization scheme for the graphical application at hand is chosen by a series of trials described at Steps A through M in FIG. 5B. After N successive frames of graphic data and commands are processed (i.e. graphically rendered) during Steps N through O, another periodical trial is performed at Steps A through M. In order to omit slow and not necessary trials, a preventive condition for any of parallelization schemes can be set and tested during Steps B, E, and H, such as used by the application of the Frame Buffer FB for the next successive frame, which prevents entering the Time Division Mode of the MMPGRS.

In the flowchart of FIG. 5C, a slightly different Periodical Trial & Error Process (also based on an empirical approach) is disclosed, wherein the tests for change of parallel graphics rendering state (i.e. mode) are done only in response to, or upon the occurrence of a drop in the frame-rate-per-second (FPS), as indicated during Steps O, and B through M.

### The Application Profiling and Analysis Module

As shown in FIG. 5D, the Application Profiling and Analysis Module (407) monitors and analyzes Performance and Interactive data streams continuously acquired by profiling the Application while its running. In FIG. 5D, the Performance Data inputs provided to the Application Profiling and Analysis Module include: texture count; screen resolution; polygon count; utilization of geometry engine, pixel engine, video memory and CPU at each GPU; the total pixels rendered, the total geometric data rendered; the workload of each GPU; the volumes of transferred data. The System-User Interactive (Device) Data inputs provided to the Application Profiling and Analysis Module include: mouse movement; head movement; voice commands; eye movement; feet movement; keyboard; LAN, WAN or Internet (WWW) originated application (e.g. game) updates.

The Tasks performed by the Application Profiling and Analysis Module include: Recognition of the Application; Processing of Trial and Error Results; Utilization of Application Profile from Behavioral Database; Data Aggregation in the Historical Depository; Analysis of input performance data (frame-based); Analysis based on integration of frame-based “atomic” performance data, aggregated data at Historical Depository, and Behavioral DB data; Detection of rendering algorithms used by Application; Detection of use of FB in next successive frame; Recognition of preventative conditions (to parallel modes); Evaluation of pixel layer depth; Frame/second count; Detection of critical events (e.g. frames/sec/drop); Detection of bottlenecks in graphics pipeline; Measure of load balance among GPUs; Update Behavioral DB from Historical Depository; and Recommendation on optimal parallel scheme.

The Application Profiling and Analysis Module performs its analysis based on the following:

(1) The performance data collected from several sources, such as vendor's driver, GPUs, chipset, and optionally—from graphic Hub;

(2) Historical repository (404) which continuously stores up the acquired data (i.e. this data having historical depth, and being used for constructing behavioral profile of ongoing application); and

(3) Knowledge based Behavioral Profile DB (405) which is an application profile library of prior known graphics applications (and further enriched by newly created profiles based on data from the Historical Depository).

In the MMGPRS of the illustrative embodiment, the choice of parallel rendering mode at any instant in time involves profiling and analyzing the system's performance by way of processing both Performance Data Inputs and Interactive Device Inputs, which are typically generated from a several different sources within MMPGRS, namely: the GPUs, the vendor's driver, the chipset, and the graphic Hub (optional).

Performance Data needed for estimating system performance and locating casual bottlenecks, includes:

(i) texture count;

(ii) screen resolution;

(iii) polygon volume;

(iv) at each GPU, utilization of
(a) the Geometry engine
(b) the Pixel engine, and
(c) Video memory;

(v) Utilization of the CPU;

(vi) total pixels rendered;

(vii) total geometric data rendered;

(viii) workload of each GPU; and

(ix) volumes of transferred data.

As shown in FIG. 5D, this Performance Data is fed as input into the Application Profiling and Analysis Module for real-time processing and analysis Application Profiling and Analysis Module. In the illustrative embodiment, the Application Profiling and Analysis Module performs the following tasks:

(1) Recognition of Application (e.g. video game, simulation, etc.);

(2) Processing of trial & error results produced by the processes described in FIGS. 5B and 5C;

(3) Utilization of the Application Profile from data in the Behavioral DB;

(4) Aggregation of Data in the Historical Repository;

(5) Analysis of Performance Data Inputs;

(6) Analysis based on the integration of
(a) Frame-based “atomic” Performance Data,
(b) Aggregated data within the Historical Repository, and
(c) Data stored in the Behavioral DB;

(7) Detection of rendering algorithms used by Application

(8) Detection of use of the FB in next successive frame as a preventive condition for Time Division Mode;

(9) Recognition of preventive conditions for other parallel modes;

(10) Evaluation of pixel layer depth at the pixel subsystem of GPU;

(11) Frame/sec count;

(12) Detection of critical events (e.g. frame/sec drop);

(13) Detection of bottlenecks in graphics pipeline;

(14) Measure and balance of load among the GPUs

(15) Update Behavioral DB from data in the Historical Depository; and

(16) Selection of the optimal parallel graphics rendering mode of operation for the MMPGRS.

### Conditions for Transition Between Object and Image Division Modes of Operation

In a well-defined case, Object Division Mode supersedes the Image Division Mode in that it reduces more bottlenecks. In contrast to the Image Division Mode that reduces only the fragment/fill bound processing at each GPU, the Object Division Mode relaxes bottleneck across the pipeline: (i) the geometry (i.e. polygons, lines, dots, etc) transform processing is offloaded at each GPU, handling only 1/N of polygons (N—number of participating GPUs); (ii) fill bound processing is reduced since less polygons are feeding the rasterizer; (iii) less geometry memory is needed; and (iv) less texture memory is needed.

Automated transition to the Object Division State of operation effectively releases the parallel graphics system of the present invention from transform and video memory loads. However, for fill loads, the Object Division State of operation will be less effective than the Image Division State of operation.

At this juncture it will be helpful to consider under what conditions a transition from the Object Division State to the Image Division State can occur, so that the parallel graphics system of the present invention will perform better “fill loads”, especially in higher resolution.

Notably, the duration of transform and fill phases differ between the Object and Image Division Modes (i.e. States) of operation. For clarity purposes, consider the case of a dual GPU graphics rendering system. Rendering time in the Image Division Mode is given by:

T_{ObjDiv}=Transform+Fill/2 (1)

whereas in Object Division Mode, the fill load does not reduce in the same factor as transform load.

The render time is:

T_{lmgDiv}=Transform/2+DepthComplexity*Fill/2 (2)

The fill function Depth Complexity in Object Division Mode depends on depth complexity of the scene. Depth complexity is the number of fragment replacements as a result of depth tests (the number of polygons drawn on every pixel). In the ideal case of no fragment replacement (e.g. all polygons of the scene are located on the same depth level), the second component of the Object Division Mode reduces to:

T_{lmgDiv}=Transform/2+Fill/2 (2.1)

However, when depth complexity becomes high, the advantage of the Object Division Mode drops significantly, and in some cases the Image Division Mode may even perform better (e.g. in Applications with small number of polygons and high volume of textures).

The function DepthComplexity denotes the way the fill time is affected by depth complexity:

$$DepthComplexity = \frac{2 E ( L / 2 )}{E ( L )} \qquad ( 3 )$$

where E(L) is the expected number of fragments drawn at pixel for L total polygon layers.

In ideal case DepthComplexity=1. In this case, E is given by:

$$E ( m ) = 1 + \frac{1}{m} ( {\sum }_{i = 1}^{m - 1} E ( i ) ) \qquad ( 3.1 )$$

For a uniform layer-depth of L throughout the scene, the following algorithm is used to find conditions for switching from the Object Division Mode to the Image Division Mode:

$$chose\_div \_mode ( Tranform , Fill ) = \{ \begin{matrix}ObjectDivision & Transform + \frac{Fill}{2} > \frac{Transform}{2} + \frac{Fill}{2} \times DepthComplexity \\ ImageDivision & otherwise\end{matrix} \qquad ( 4 )$$

In order to choose between the Image Division and the Object Division Mode, an algorithm is used which detects which transform and fill bound processing is smaller. Once the layer-depth reaches some threshold value throughout the scene, the Object Division Mode will not minimize the Fill function any more.

### EXAMPLE

### Consideration of a General Scene

Denote the time for drawing n polygons and p pixels as Render(n,p), and allow P to be equal to the time taken to draw one pixel. Here the drawing time is assumed to be constant for all pixels (which may be a good approximation, but is not perfectly accurate). Also, it is assumed that the Render function, which is linearly dependent on p (the number of pixels actually drawn), is independent of the number of non-drawings that were calculated. This means that if the system has drawn a big polygon that covers the entire screen surface first, then for any additional n polygons: Render(n, p)=p×P.

$$Render ( n , p ) = {\sum }_{i = 1}^{∞} P \times \vert \{ x \vert LayerDepth ( x ) = i \} \vert \times E ( i ) \qquad ( 5 )$$

The screen space of a general scene is divided into sub-spaces based on the layer-depth of each pixel. This leads to some meaningful figures.

For example, suppose a game engine generates a scene, wherein most of the screen (90%) has a depth of four layers (the scenery) and a small part is covered by the player (10%) with a depth of 20 layers. Without Object Division Mode support, the value of Render function is given by:

Render(n,p)=p×0.9×E(4)+p×0.1×E(20)=2.2347739657143681×p

With Object Division Mode support, the value of the Render function is:

Render(n/2,p)=p×0.9×E(4/2)+p×0.1×E(20/2)=1.6428968253968255×p

Notably, in this case, the improvement factor when using Object Division Mode support is 1.3602643398952217. On the other hand, a CAD engine might have a constant layer depth of 4. The following table shows the improvement factor for interesting cases:

| | Small | Object-Division, |
|---|---|---|
| Big part (90%) | part (10%) | improvement factor |
| depth | layer depth | the Render function |
| X | x | E(x) (this follows immediately from |
| 2 | 4 | 1.4841269841269842 |
| 4 | 2 | 1.3965517241379308 |
| 10 | 100 | 1.2594448158034022 |

It is easily seen that when the layer depth DepthComplexity becomes larger, the Object Division Mode does not improve the rendering time by a large amount, and if rendering time is the bottleneck of the total frame calculation procedure, then the Image Division Mode might be a better approach.

The analysis results by Application Profiling and Analysis Module are passed down to the next module of Parallel Policy Management Module.

### Parallel Policy Management Module

Parallel Policy Management Module (408) makes the final decision regarding the preferred mode of parallel graphics rendering used at any instant in time within the MMPGRS, and this decision is based on the profiling and analysis results generated by the Application Profiling and Analysis Module. The decision is made on the basis of some number N of graphics frames. As shown above, the layer depth factor, differentiating between the effectiveness of the Object Division vs. Image Division Mode, can be evaluated by analyzing the relationship of geometric data vs. fragment data at a scene, or alternatively can be found heuristically. Illustrative control policies have been described above and in FIGS. 5A through 5C.

### Distributed Graphic Function Control Module

Distributed Graphic Function Control Module (409) carries out all the functions associated with the different parallelization modes, according to the decision made by the Parallel Policy Management Module. The Distributed Graphic Function Control Module (409) drives directly the configuration sub-states of the Decomposition, Distribution and Recomposition Modules, according to the parallelization mode. Moreover, Application Profiling and Analysis includes drivers needed for hardware components such as graphic Hub, described hereinafter in the present Patent Specification.

### The MMPGRS of the Present Invention has Embodiments Based on Both Software and Hardware System Architectures

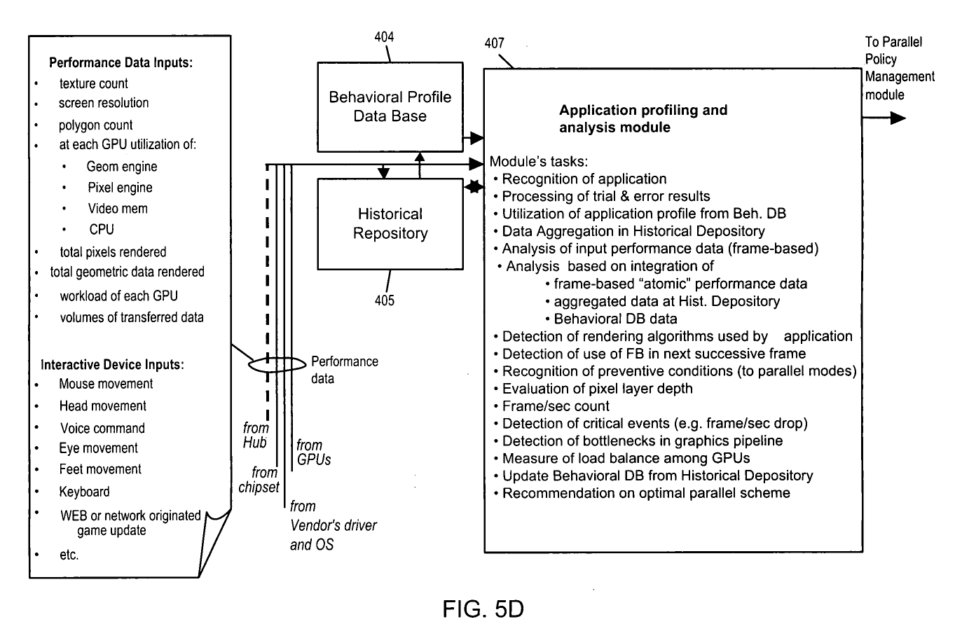

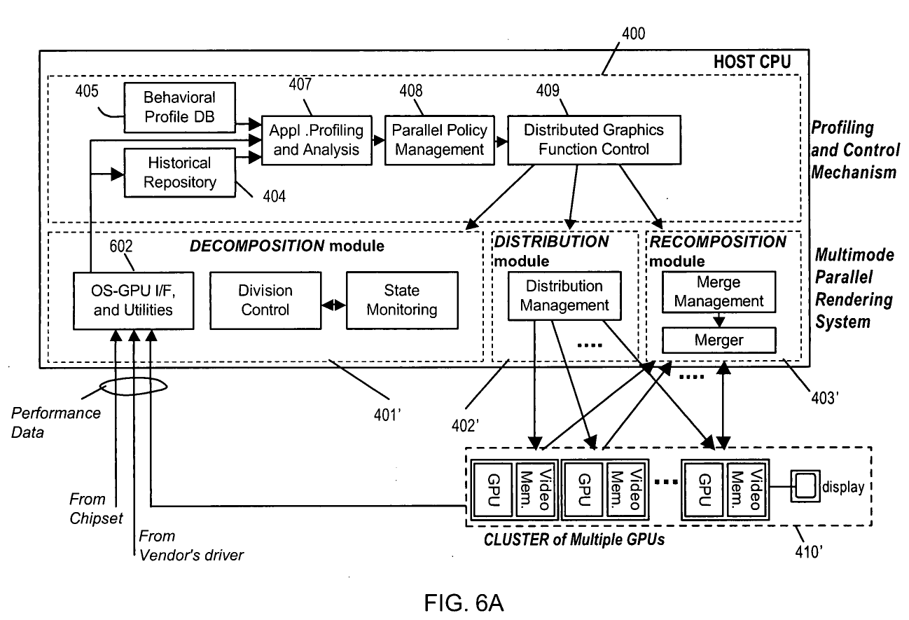

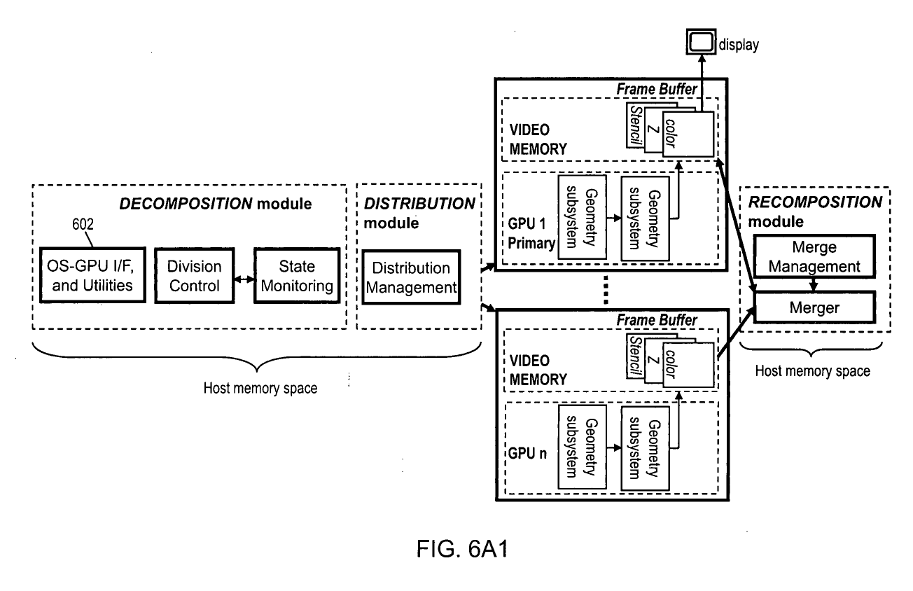

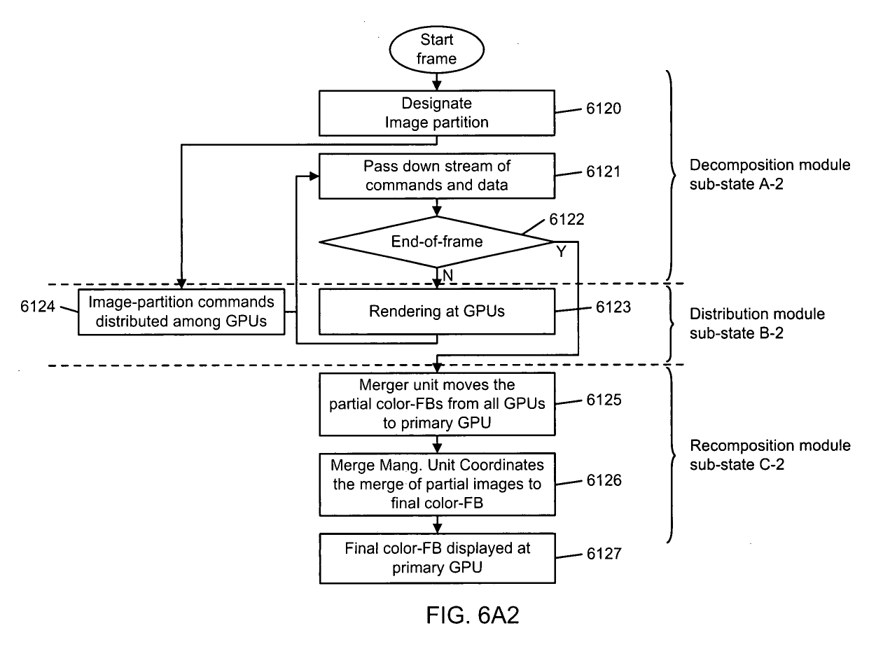

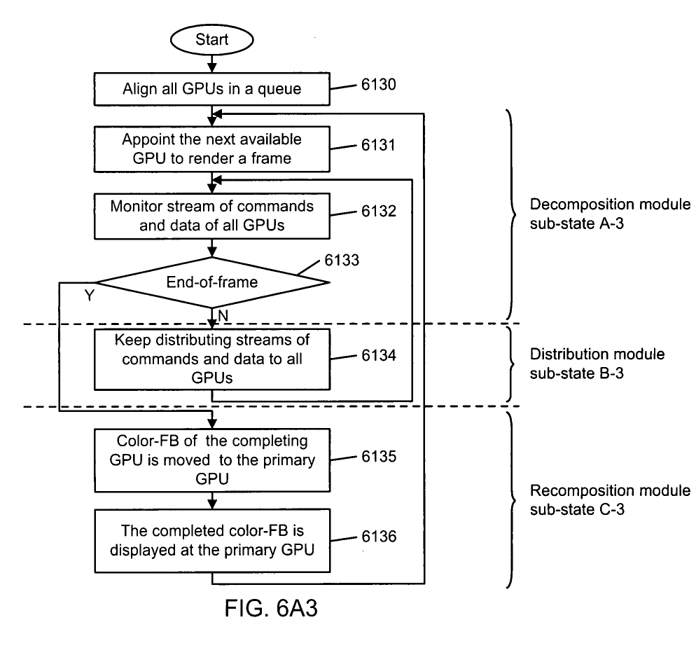

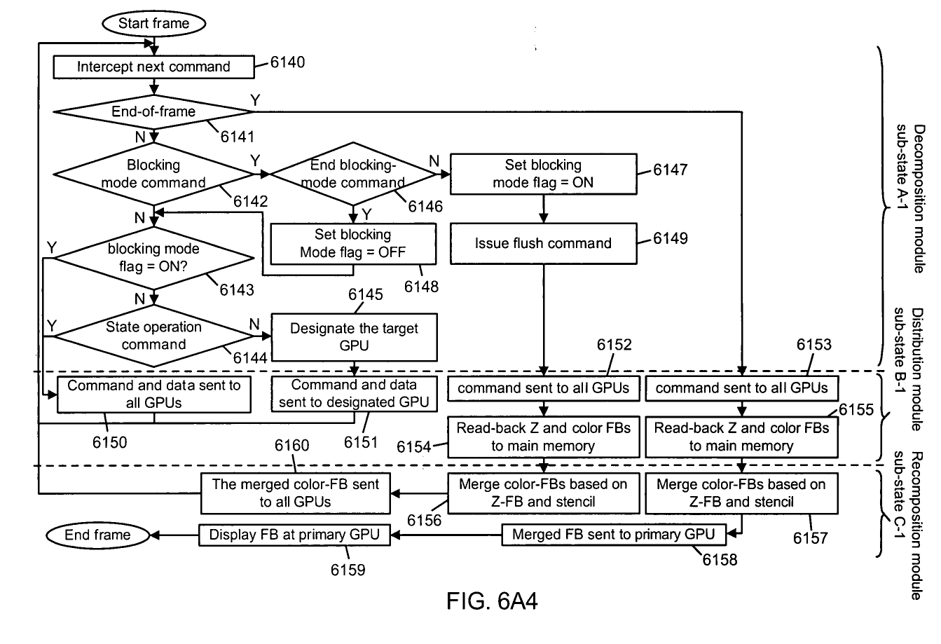

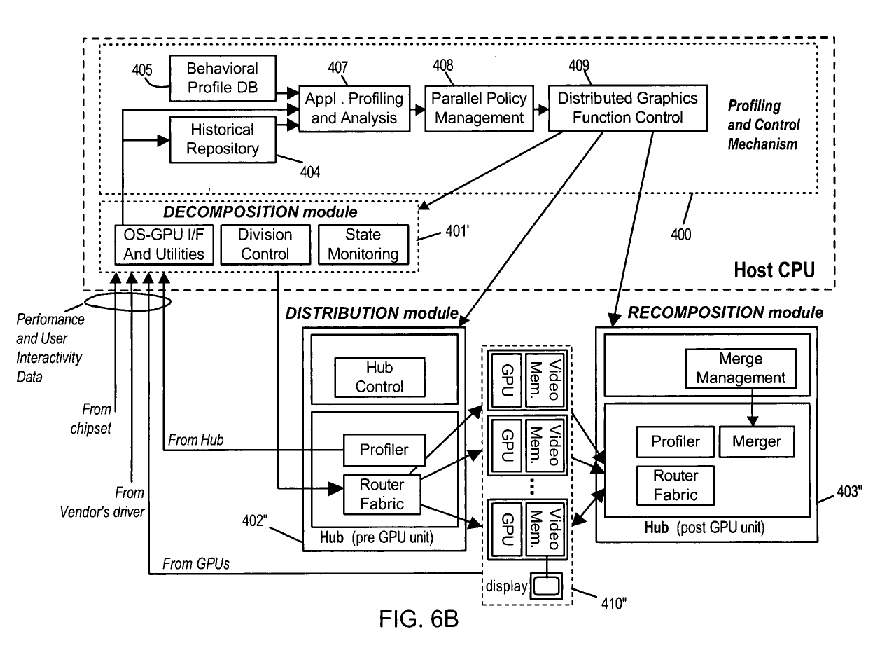

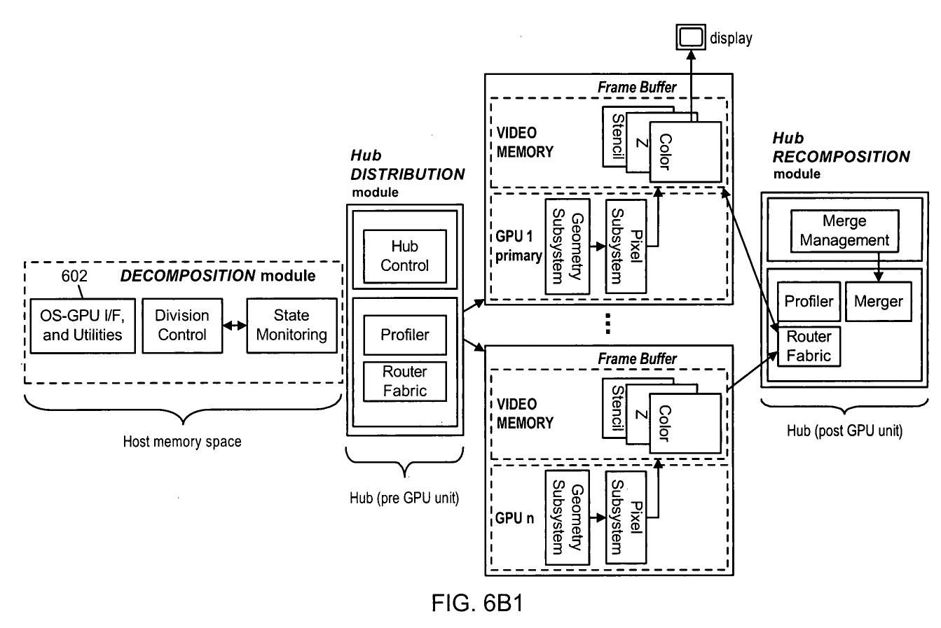

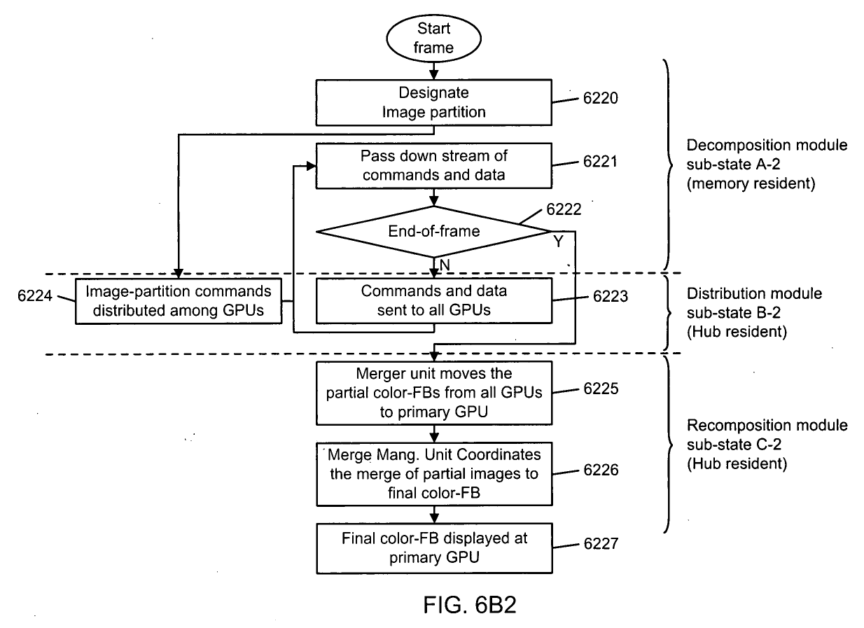

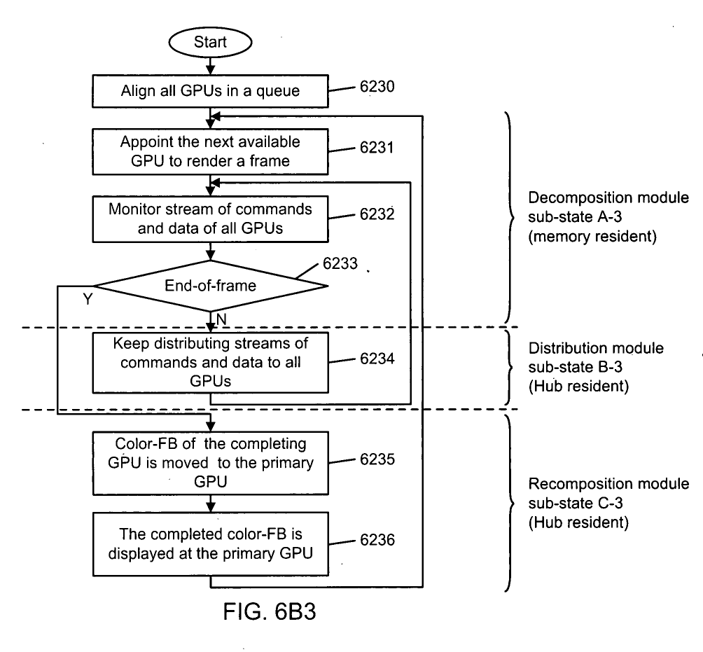

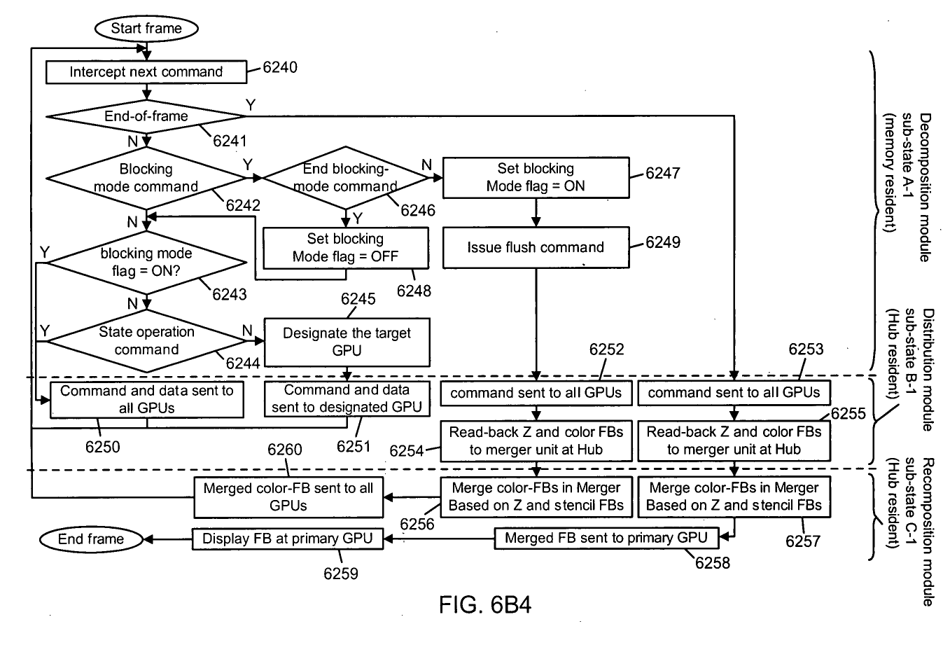

The MMPGRS of the present invention can be realized using two principally different kinds of system architectures, namely: a software-based system architecture illustrated in FIGS. 6A through 6A4; and a hardware-based system architecture illustrated in FIGS. 6B through 6B4. However, both of these generalized embodiments are embraced by the scope and spirit of the present invention illustrated in FIG. 4A.

### The Generalized Software Architecture of Present Invention

The generalized software-based system architecture of the MMGPRS will be described in connection with FIGS. 6A through 6A4.

As illustrated in FIG. 6A, a generalized software architecture for the MMPGRS of the present invention is shown comprising the Profiling and Control Mechanism (PCM) (400) that supervises the flexible parallel structure of the Multi-Mode Parallel (multi-GPU) Graphics Rendering Subsystem (410). The Profiling and Control Mechanism has been already thoroughly described in reference to FIG. 4A.

As shown in FIG. 6A, the Multi-Mode Parallel Graphics Rendering Subsystem (410) comprises Decomposition Module (401′), Distribution Module (402′), Recomposition Module (403′), and a Cluster of Multiple GPUs (410′).

The Decomposition Module is implemented by three software modules, namely the OS-GPU interface and Utilities Module, the Division Control Module and the State Monitoring Module. These sub-modules will be described in detail below.

### The OS-GPU Interface and Utilities Module

The OS-GPU Interface and Utilities Module performs all the functions associated with interaction with the Operating System (OS), Graphics Library (e.g. OpenGL or DirectX), and interfacing with GPUs. OS-GPU Interface and Utilities Module is responsible for interception of the graphic commands from the standard graphic library, forwarding and creating graphic commands to the Vendor's GPU Driver, controlling registry, installations, OS services and utilities. Another task of this module is reading Performance Data from different sources (e.g. GPUs, vendor's driver, and chipset) and forwarding the Performance Data to the Profiling and Control Mechanism (PCM).

### The Division Control Module

The Division Control Module controls the division parameters and data to be processed by each GPU, according to parallelization scheme instantiated at any instant of system operation (e.g. division of data among GPUs in the Object Division Mode, or the partition of the image screen among GPUs in the Image Division Mode).

In the Image Division Mode the Division Control Module assigns for duplication all the geometric data and common rendering commands to all GPUs. However specific rendering commands to define clipping windows corresponding to image portions at each GPU, are assigned separately to each GPU.

In the Object Division Mode, polygon division control involves sending each polygon (in the scene) randomly to a different GPU within the MMPGRS. This is an easy algorithm to implement, and it turns out to be quite efficient. There are different variations of this basic algorithm, as described below.

### Polygon Division Control by Distribution of Vertex Arrays

According to this method, instead of randomly dividing the polygons, every even polygon can be sent to GPU1 and every odd polygon to GPU2 in a dual GPU system (or more GPUs accordingly). Alternatively, the vertex-arrays can be maintained in their entirety and sent to different GPUs, as the input might be in the form of vertex arrays, and dividing it may be too expensive.

### Polygon Division Control by Dynamic Load Balancing

According to this method, GPU loads are detected at real time and the next polygon is sent to the least loaded GPU. Dynamic load balancing is achieved by building complex objects (out of polygons). GPU loads are detected at real time and the next object is sent to the least loaded GPU.

### Handling State Validity Across the MMPGRS by State Monitoring

The graphic libraries (e.g. OpenGL and DirectX) are state machines. Parallelization must preserve a cohesive state across all of the GPU pipelines in the MMPGRS. According to this method, this is achieved by continuously analyzing all incoming graphics commands, while the state commands and some of the data is duplicated to all graphics pipelines in order to preserve the valid state across all of the graphic pipelines in the MMPGRS. This function is exercised mainly in Object Division Mode, as disclosed in detail in Applicant's previous International Patent PCT/IL04/001069, now published as WIPO International Publication No. WO 2005/050557, incorporated herein by reference in its entirety.

### The Distribution Module

The Distribution Module is implemented by the Distribution Management Module, which addresses the streams of graphics commands and data to the different GPUs via chipset outputs, according to needs of the parallelization schemes instantiated by the MMPGRS.

In the illustrative embodiments, the Recomposition Module is realized by two modules: (i) the Merge Management Module which handles the reading of frame buffers and the compositing during the Test-Based, Screen-Based And None Sub-States; and (ii) the Merger Module which is an algorithmic module that performs the different compositing algorithms, namely: Test Based Compositing during the Test-Based Sub-state; and Screen Based Compositing during the Screen-Based Sub-state.

The Test-Based Compositing suits compositing during the Object Division Mode. According to this method, sets of Z-buffer, stencil-buffer and color-buffer are read back from the GPU FBs to host's memory for compositing. The pixels of color-buffers from different GPUs are merged into single color-buffer, based on per pixel comparison of depth and/or stencil values (e.g. at given x-y position only the pixel associated with the lowest z value is let out to the output color-buffer). This is a software technique to perform hidden surface elimination among multiple frame buffers required for the Object Division Mode. Frame buffers are merged based on depth and stencil tests. Stencil tests, with or without combination with depth test, are used in different multi-pass algorithms. The final color-buffer is down-loaded to the primary GPU for display.

Screen-Based Compositing suits compositing during the Image Division Mode. The Screen-Based compositing involves a puzzle-like merging of image portions from all GPUs into a single image at the primary GPU, which is then sent out to the display. This method is a much simpler procedure than the Test-Based Compositing Method, as no tests are needed. While the primary GPU is sending its color-buffer segment to display, the Merger Module reads back other GPUs color-buffer segments to host's memory, for downloading them into primary GPU's FB for display.

The None Sub-state is a non-compositing option which involves moving the incoming Frame Buffer to the display. This option is used when no compositing is required. In the Time Division Mode, a single color-buffer is read back from a GPU to host's memory and downloaded to primary GPU for display. In the Non-Parallel Mode (e.g. employing a single GPU), usually the primary GPU is employed for rendering, so that no host memory transit is needed.

As shown in FIG. 6A1, in the software-architecture of the MMPGRS, the Distribution Module and the Decomposition Mode both reside in the host memory space, and drive the cluster of GPUs according to one of the parallel graphics rendering (division) modes supported by the MMPGRS.

The parallel graphics rendering process performed during each mode of parallelism will now be described with reference to the flowcharts set forth in FIGS. 6A2, 6A3 and 6A4, for the Image, Time and Object Division Modes, respectively.

### Parallel Graphics Rendering Process for a Single Frame During the Image Division Mode of the MMPRS Implemented According to the Software-Based Architecture of the Present Invention

In FIG. 6A2, the parallel graphics rendering process for a single frame is described in connection with the Image Division Mode of the MMPRS implemented according to the software-based architecture of the present invention. In the Image Division Mode, the Decomposition, Distribution and Recomposition Modules are set as follows: the Decomposition Module is set on sub-state A-2, the Distribution Module is set on sub-state B-2, and the Recomposition Module is set on sub-state C-2. The Decomposition Module splits up the image area into sub-images and prepares partition parameters for each GPU (6120). Typically, the partition ratio is dictated by the Profile and Control Mechanism based on load balancing considerations. The physical distribution of these parameters among multiple GPUs is done by the Distribution Module (6124). From this point on the stream of commands and data (6121) is broadcasted to all GPUs for rendering (6123), unless end-of-frame is encountered (6122). When rendering of frame is accomplished, each GPU holds a different part of the entire image. Compositing of these parts into final image is done by the Recomposition Module moving all partial images (i.e. color-FB) from GPUs to primary GPU (6125), merging the sub-images into final color-FB (6126), and displaying the FB on the display screen (6127).

### Parallel Graphics Rendering Process for a Single Frame During the Time Division Mode of the MMPRS Implemented According to the Software-Based Architecture of the Present Invention

In FIG. 6A3, the parallel graphics rendering process for a single frame is described in connection with the Time Division Mode of the MMPRS implemented according to the software-based architecture of the present invention. In the Time Division Mode, the Decomposition, Distribution and Recomposition Modules are set as follows: the Decomposition Module is set on sub-state A-3, the Distribution Module is set on sub-state B-3, and the Recomposition Module is set on sub-state C-3. The Decomposition Module aligns a queue of GPUs (6130), appoints the next frame to the next available GPU (6131), and monitors the stream of commands and data to all GPUs (6132). The physical distribution of that stream is performed by the Distribution Module (6134). Upon detection of end-of-frame (6133) at one of the GPUs, the control moves to Recomposition Module which moves the color-FB of the completing GPU, to primary GPU (6135). The primary GPU the displays the image on display screen (6136).

### Parallel Graphics Rendering Process for a Single Frame During the Object Division Mode of the MMPRS Implemented According to the Software-Based Architecture of the Present Invention

In FIG. 6A4, the parallel graphics rendering process for a single frame is described in connection with the Object Division Mode of the MMPRS implemented according to the software-based architecture of the present invention. In the Object Division Mode, the Decomposition, Distribution and Recomposition Modules are set as follows: the Decomposition Module is set on sub-state A-1, the Distribution Module is set on sub-state B-1, and the Recomposition Module is set on sub-state C-1. The Decomposition Module activity starts with interception of graphics commands (6140) on their way between standard graphics library (e.g. OpenGL, Dirct3D) and vendor's GPU driver. Each graphics command is tested for blocking mode (6142, 6143) and state operation class (6144). Blocking operations are exceptional in that they require a composed valid FB data, thus in the Object Division Mode, they have an inter-GPU effect. Therefore, whenever one of the blocking operations is issued, all the GPUs must be synchronized. Each frame has at least 2 blocking operations: Flush and Swap, which terminate the frame. State operations (e.g. definition of light source) have an across the board effect on all GPUs. In both cases the command must be duplicated to all GPUs, rather than delivered to one of them. Therefore the Distribution Module physically sends the command to all GPUs (6150). On the other hand, a regular command that passed the above tests is designated to a single target GPU (6145), and sent by Distribution Module to that GPU (6151).

When a blocking mode command is detected (6143), a blocking flag is set on (6147) indicating blocking state. At this point, a composition of all frame buffers must occur and its result be duplicated to all GPUs. The rendering of upcoming commands is mirrored (duplicated) at all of the GPUs, unless an end-of-blocking mode is detected. The compositing sequence includes issuing of a flushing command (6149) to empty the pipeline. Such a command is sent to all GPUs (6152). Then at each GPU the color and Z Frame Buffer are read back to host memory (6154), and all color Frame Buffers are composited based on Z and stencil buffers (6156). Finally, the resulting Frame Buffer is sent to all GPUs (6160). All successive graphics commands will be duplicated (i.e. replicated) to all GPUs generating identical rendering results, unless the blocking mode flag is turned off. When the end-of-blocking mode is detected (6146), the blocking flag is turned off (6148) and regular object division is resumed.

When detected (6144) by the Decomposition Module, state operation commands (e.g. glLight, glColor) are being duplicated to all GPUs (6150). Upon End-of-frame detection (6141), a compositing process is taking place (6153, 6155, 6157, 6158), very similar to that of blocking mode. However the merging result is sent to the primary GPU's display screen.

The Generalized Hardware Hub Based Architecture of Present Invention

The generalized hardware-based system architecture of the MMGPRS is realized as a Graphics-Hub Based Architecture which will be described in connection with FIGS. 6B through 6B4.

The main difference of hardware-based architecture over the software based architecture of present invention is in performing the Distribution and Recomposition tasks by specialized hardware, the graphics Hub. This Hub intermediates between the Host CPU and the GPUs. There are two major advantages to hardware approach.

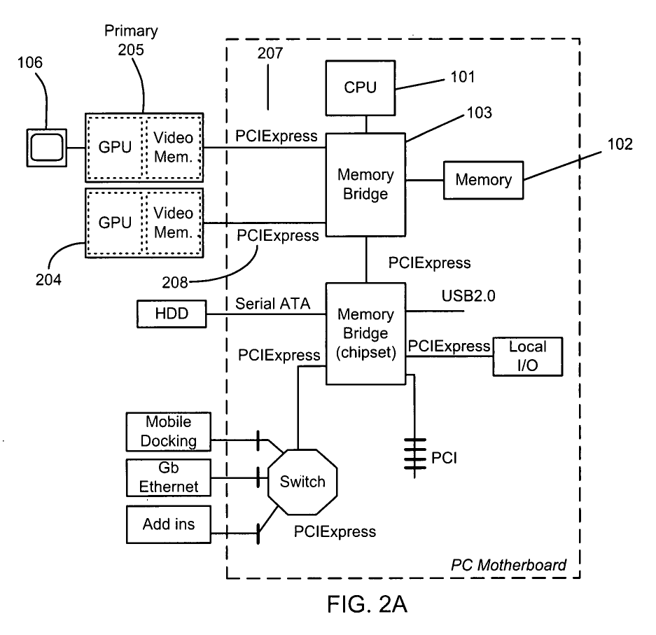

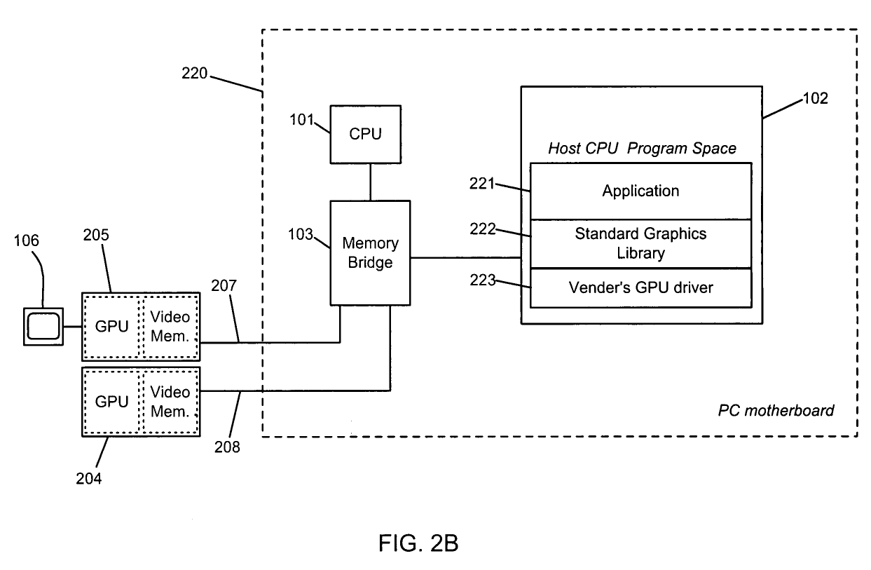

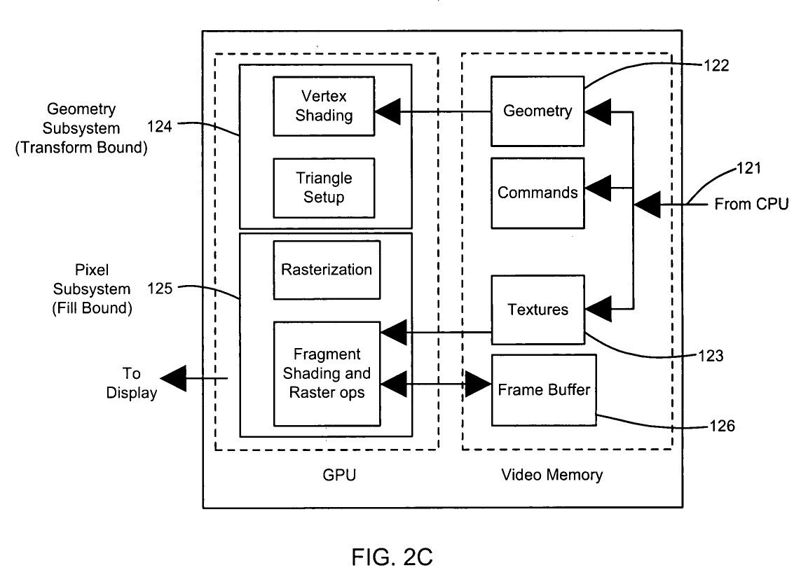

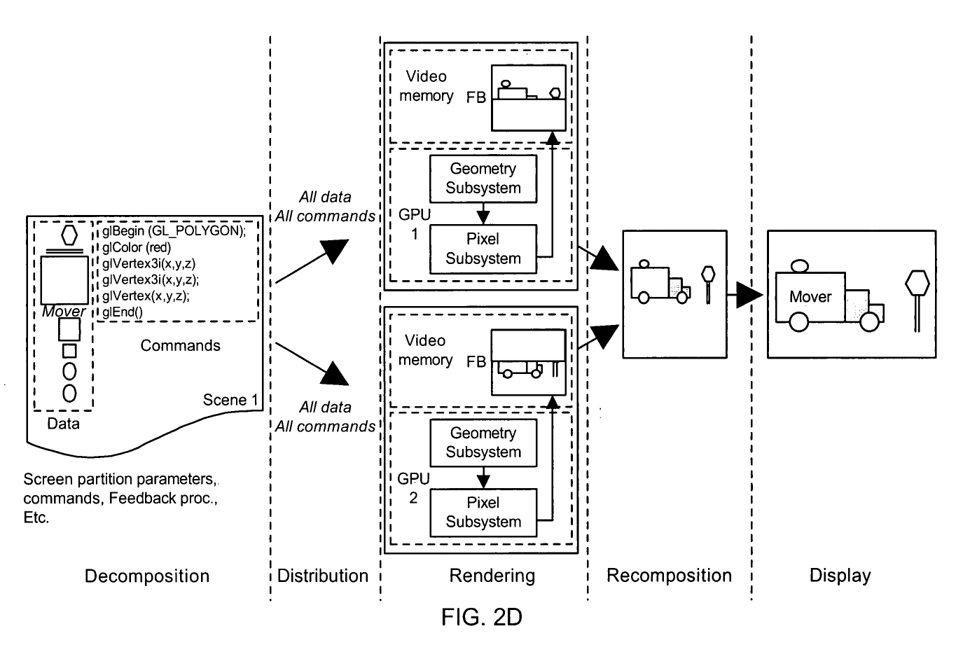

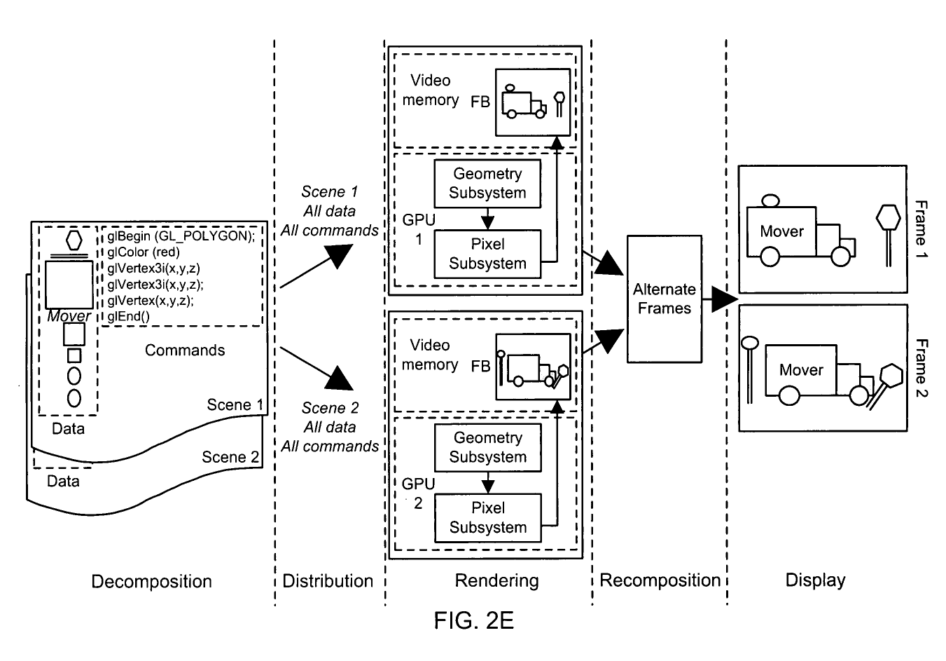

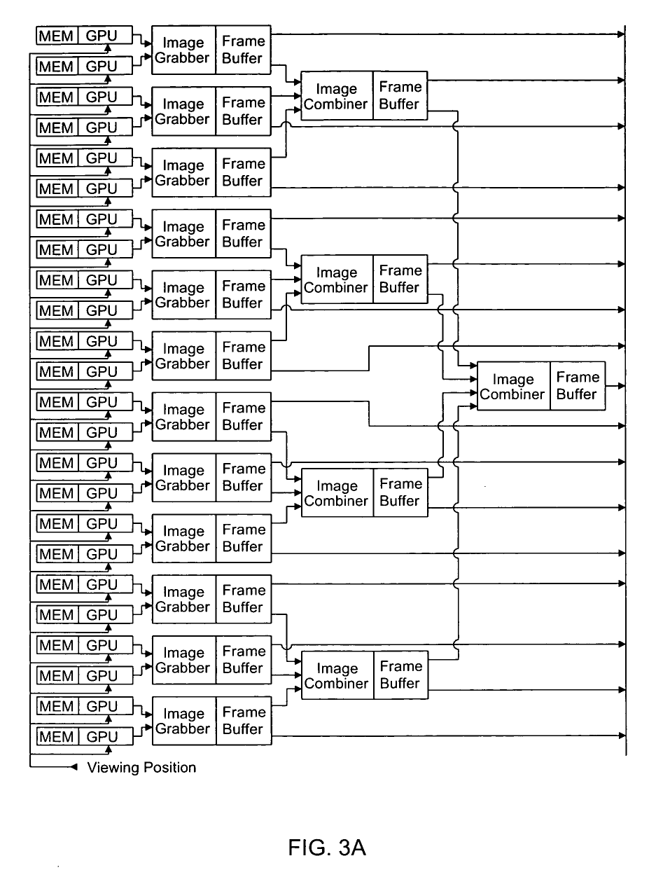

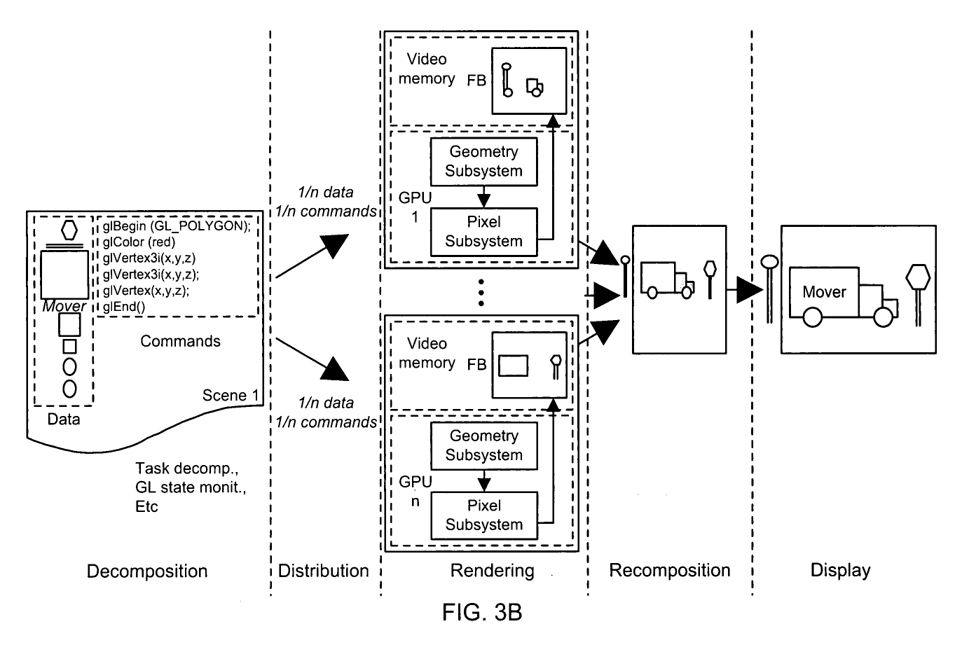

One advantage is the number of driven GPUs in the system which is not limited any more by the number of buses provided by the Memory Bridge (207, 208 in FIG. 2A of prior art), which are typically 1-2 in prior art. The Router Fabric components in Hub allow connection of (theoretically) unlimited number of GPUs to the Host CPU.

The other advantage is the high performance of recomposition task which is accomplished in the Hub, eliminating the need of moving the Frame Buffer data from multiple GPUs to the Host memory for merge, as it is done in the Software Architecture of present invention. Here the merge task is done by fast, specialized hardware, independent of other tasks concurrently trying to access the main memory as happens in a multitasking computing system of Software Based Architecture.

As shown in FIG. 6B, the Profiling and Control Mechanism (400) supervises the flexible Hub-based structure creating a real-time adaptively parallel multi-GPU system. As the Profiling and Control Mechanism (400) has been previously described in great detail with reference to FIG. 4A, technical attention here will focus on the Decomposition (401′), Distribution (402″), and Recomposition (403″) Modules within the hard-ware embodiment of the MMPGRS of the present invention. Notably, the Decomposition Module is a software module residing in the host system, while Distribution and Recomposition Modules are hardware-based components residing in the Hub hardware, external to the host system.

In the hardware embodiment of the MMPGRS, the Decomposition Module is generally similar to the Decomposition Module realized in the software embodiment, described above. Therefore, attention below will focus only on the dissimilarities of this module in hardware and software embodiments of the MMPGRS of the present invention.

### The OS-GPU Interface and Utilities Module

As shown in FIG. 6B, an additional source of Performance Data (i.e. beyond the GPUs, vendor's driver, and chipset) includes the internal profiler employed in the Hub Distribution Module. Also, an additional function of the OS-GPU Interface and Utilities Module is driving the Hub hardware by means of a soft driver.

### The Division Control Module

In the Division Control Module, all graphics commands and data are processed for decomposition and marked for division. However, these commands and data are sent in a single stream into the Distribution Module of the Hub for physical distribution. As shown in FIG. 6B, the function of the Graphic Hub hardware is to interconnect the host system and the cluster of GPUs. The Graphic Hub supports the basic functionalities of the Distribution Module (402″) and the Recomposition Module (403″). From a functional point of view, the Distribution Module resides before the cluster of GPUs, delivering graphics commands and data for rendering (the “pre GPU unit”), and the Recomposition Module that comes after the cluster of GPUs, and collects post rendering data (“post GPU unit”). However, physically, both the Distribution Module and the Recomposition Module share the same hardware unit (e.g. silicon chip).

As shown in FIG. 6B, the Distribution Module (402″) comprises three functional units: the Router Fabric, the Profiler, and the Hub Control modules.

The Router Fabric is a configurable switch that distributes the stream of geometric data and commands to the GPUs. An illustrative example of Router Fabric is a 5 way PCI express x16 lanes switch, having one upstream path between Hub and CPU, and 4 downstream paths between Hub and four GPUs. In general, the function of the Router Fabric is to (i) receive upstream of commands and data from the CPU, and transfer them downstream to GPUs, under the control of Division Control unit (of Decomposition module). The control can set the router into one of the following transfer sub-states: Divide, Broadcast, and Single. The Divide sub-state is set when the MMGPRS is operating in its Object Division Mode. The Broadcast sub-state is set when the MMGPRS is operating in its Image Division Mode. The Single sub-state is set when the MMGPRS is operating in its Time Division Mode. (ii) receive Frame Buffer data from GPUs for compositing in the Merger unit (of the Recomposition Module).

The Profiler of Hub pre-GPU unit has three functions: (i) to deliver to Division Control its own generated profiling data, (ii) to forward the profiling data from GPUs to Division Control, due the fact that the GPUs are not directly connected to the Host, as it is in the Software Architecture of present invention, and (iii) to forward the Hub post-GPU profiling data to the Division Control block. The Profiler, being close to the raw data passing by, monitors the stream of geometric data and commands, for Hub profiling purposes. Such monitoring operations involve polygon, command, and texture count and quantifying data structures and their volumes for load balance purposes. The collected data is mainly related to the performance of the geometry subsystem employed in each GPU. Another part of Hub profiling is resident to the Recomposition Module which profiles the merge process and monitors the task completion of each GPU for load balancing purposes. Both profilers unify their Performance Data and deliver it, as feedback, to the Profiling and Control Mechanism, via the Decomposition Module, as shown in FIG. 6B. The linkage between the two profiling blocks is not shown in FIG. 6B, similarly to other inter-block connections within the Hub, which for clarity reasons are not explicitly shown. The two parts of the Hub, the pre-GPU and post-GPU units, may preferably reside on the same silicon chip, having many internal interconnections, all hidden in FIG. 6B.

The Hub Control module, a central control unit within the Hub 401″, works under control of the Distributed Graphics Function Control Module (409) within the Profiling and Control Mechanism (400). The primary function performed by the Hub Control module is to configure the Router Fabric according to the various parallelization modes and to coordinate the overall functioning of hardware components across the Hub chip.

The Recomposition Module (403″) consists of hardware blocks of Merge Management, Merger, Profiler and Router Fabric. It primary function is to bring in the Frame Buffer data from multiple GPUs, merge these data according to the on-going parallelization mode, and move it out for display.

The Merge Management block's primary function is to handle the read-back of GPUs Frame Buffers and configure the Merger block to one of the sub-states—Test Based, Screen Based and None—described above in great detail.

The Merger Module is an algorithmic module that performs the different compositing algorithms for the various division modes.

The Router Fabric Module is a configurable switch (e.g. 4 way PCI express ×16 lanes switch) that collects the streams of read-back FB data from GPUs, to be delivered to the Merger Module. Optionally, the Router Fabric module of Recomposition module can be unified with the Router Fabric of Distribution module, to perform both functions which, fortunately, do not overlap in time: distribution of commands and data for rendering occurs during the buildup of Frame Buffers, while read-back of Frame Buffers for composition occurs upon accomplishing their buildup.

As shown in FIG. 6B1, in the hardware-based architecture of the MMPGRS, the Decomposition Module is realized as a software module and resides in the host memory space of the host system, while the Distribution and Recomposition Modules are realized as hardware components of the Graphics Hub, and drive the cluster of GPUs according to one of the parallel graphics rendering division modes. The parallel graphics rendering process performed during each mode of parallelism will now be described with reference to the flowcharts set forth in FIGS. 6B2, 6B3 and 6B4, for the Image, Time and Object Division Modes, respectively.

### Parallel Graphics Rendering Process for a Single Frame During the Image Division Mode of the MMPRS Implemented According to the Software-Based Architecture of the Present Invention

In FIG. 6B2, the parallel graphics rendering process for a single frame is described in connection with the Image Division Mode of the MMPRS implemented according to the software-based architecture of the present invention. In the Image Division Mode, the Decomposition, Distribution and Recomposition Modules are set as follows: the Decomposition Module is set on sub-state A-2, the Distribution Module is set on sub-state B-2, and the Recomposition Module is set on sub-state C-2. The Decomposition Module splits up the image area into sub-images and prepares partition parameters for each GPU (6220). Typically, the partition ratio is dictated by the Profile and Control Mechanism based on load balancing considerations. The physical distribution of these parameters among multiple GPUs is done by Distribution Module (6224). From this point onward, the stream of graphics commands and data (6121) is broadcasted to all GPUs for rendering (6223), unless end-of-frame is encountered (6222). When rendering of frame is accomplished, each GPU holds a different part of the entire image. Compositing of these parts into final image is done by the Recomposition Module by moving all partial images (i.e. color-FB) from the GPUs to primary GPU (6225), merging the sub-images into final color-FB (6226), and displaying the FB on the display screen (6227).

### Parallel Graphics Rendering Process for a Single Frame During the Time Division Mode of the MMPRS Implemented According to the Software-Based Architecture of the Present Invention

In FIG. 6B3, the parallel graphics rendering process for a single frame is described in connection with the Time Division Mode of the MMPRS implemented according to the software-based architecture of the present invention. In the Time Division Mode, the Decomposition, Distribution and Recomposition Modules are set as follows: the Decomposition Module is set on sub-state A-3, the Distribution Module is set on sub-state B-3, and the Recomposition Module is set on sub-state C-3. The Decomposition Module aligns a queue of GPUs (6230), appoints the next frame to the next available GPU (6231), and monitors the stream of graphics commands and data to all GPUs (6232). The physical distribution of that stream is performed by the Distribution Module (6234). Upon detection of an end-of-frame (6233) at one of the GPUs, the control moves to Recomposition Module which moves the Color-FB (of the completing GPU) to primary GPU (6235). The primary GPU then displays the image on display screen (6236).

### Parallel Graphics Rendering Process for a Single Frame During the Object Division Mode of the MMPRS Implemented According to the Software-Based Architecture of the Present Invention

In FIG. 6B4, the parallel graphics rendering process for a single frame is described in connection with the Object Division Mode of the MMPRS implemented according to the software-based architecture of the present invention. In the Object Division Mode, the Decomposition, Distribution and Recomposition Modules are set as follows: the Decomposition Module is set on sub-state A-1, the Distribution Module is set on B-1, and the Recomposition Module is set on sub-state C-1. The Decomposition Module activity starts with interception of commands (6240) on their way between standard graphics library (e.g. OpenGL, Dirct3D) and vendor's GPU driver. Each graphics command is tested for blocking mode (6242, 6243) and state operation class (6244). Blocking operations are exceptional in that they require a composed valid FB data, thus in the parallel setting of object division, they have an inter-GPU effect. Therefore, whenever one of the blocking operations is issued, all the GPUs must be synchronized. Each frame has at least 2 blocking operations: Flush and Swap, which terminate the frame. State operations (e.g. definition of light source) have an across the board effect on all GPUs. In both cases the command must be duplicated to all GPUs, rather than delivered to one of them. Therefore the Distribution Module physically sends the command to all GPUs (6250). On the other hand, a regular command that passed the above tests is designated to a single target GPU (6245), and sent by the Distribution Module to that GPU (6251).

When a blocking mode command is detected (6243), a blocking flag is set on (6247) indicating blocking state. At this point in the process, a composition of all frame buffers must occur and its result duplicated to all GPUS. The rendering of upcoming commands is mirrored (i.e. duplicated) at all of them, unless an end-of-blocking mode is detected. The compositing sequence includes issuing of a flushing command (6249) to empty the pipeline. Such a command is sent to all GPUs (6252). Then, at each GPU, the Color and Z Frame Buffers are read back to Merger Module at the Hub (6254), and all Color Frame Buffers are composited based on data within the Z and Stencil Buffers (6256). Finally, the resulting Frame Buffer is sent to all GPUs (6260). All successive commands will be duplicated to all GPUs generating identical rendering results, unless the blocking mode flag is turned off. When the end-of-blocking mode is detected (6246), the blocking flag is turned off (6248) and regular object division is resumed.

State operation commands (e.g. glLight, glColor), when detected (6244) by the Decomposition Module, are duplicated to all GPUs (6250). Upon End-of-frame detection (6241), a compositing process occurs (6253, 6255, 6257, 6258), in a manner similar to the blocking mode. But this time, the merged result is sent to the display screen connected to the primary GPU.

### Illustrative Design for the Multi-Mode Parallel Graphics Rendering System (MMPGRS) of the Present Invention Having a Software-Based System Architecture Parallelizing the Operation of Multiple GPUs

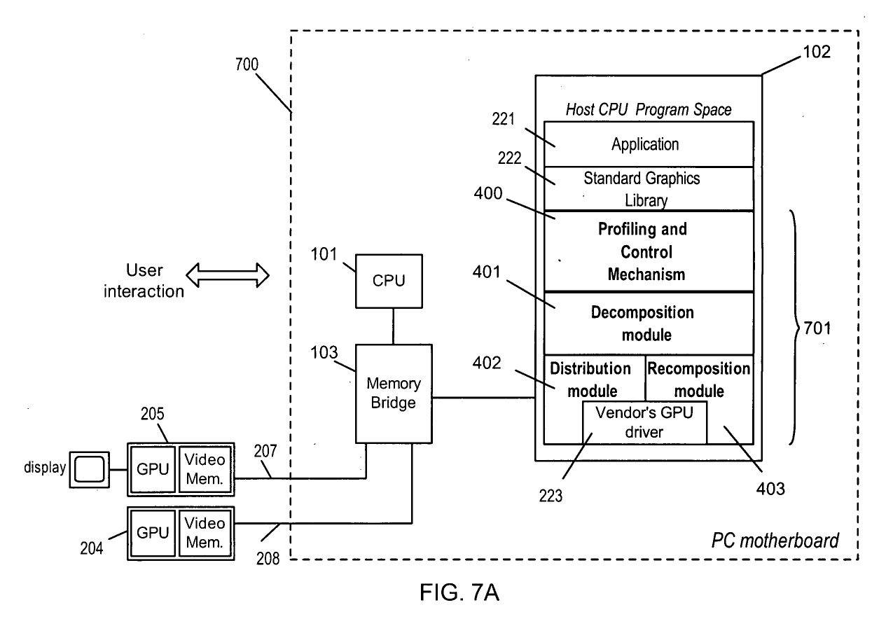

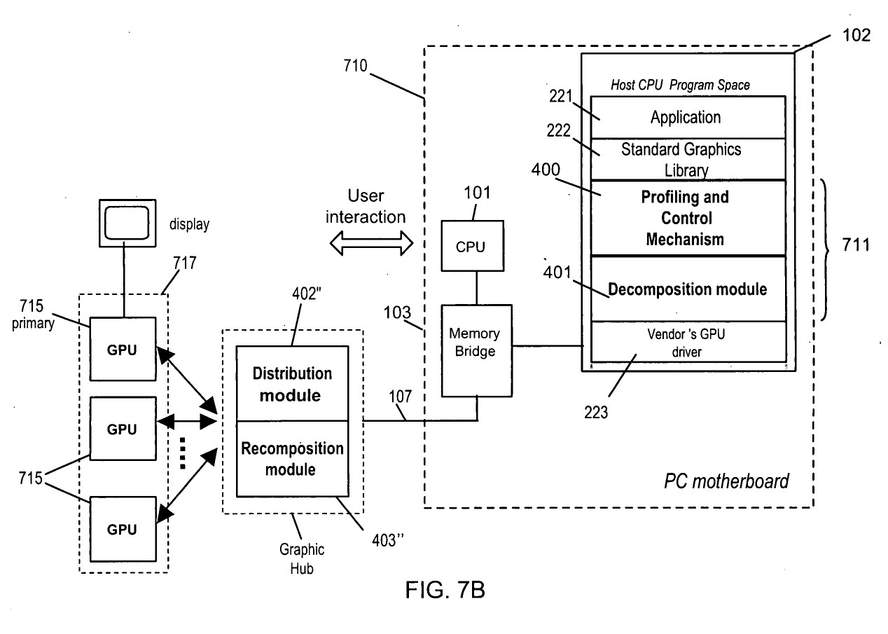

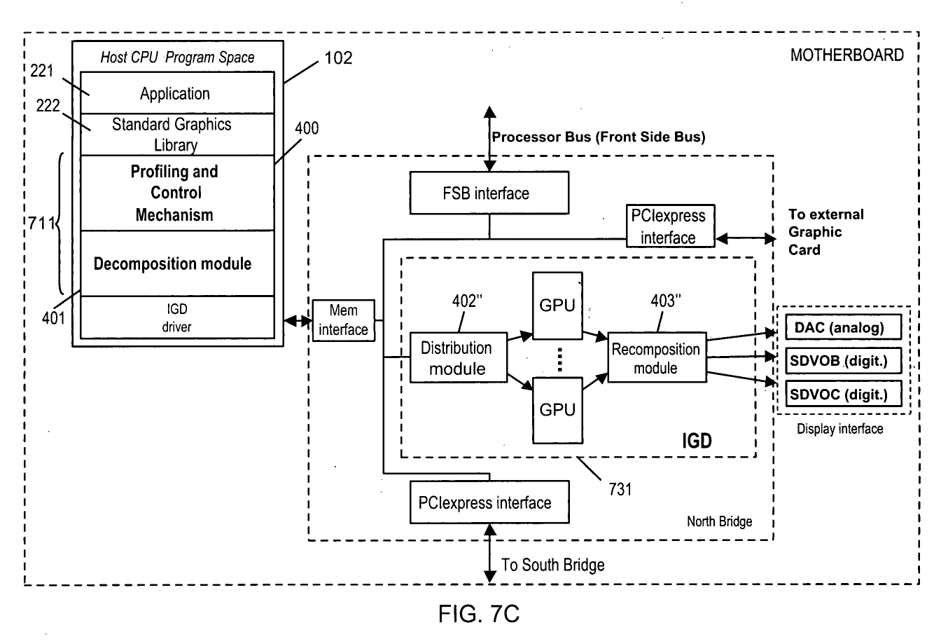

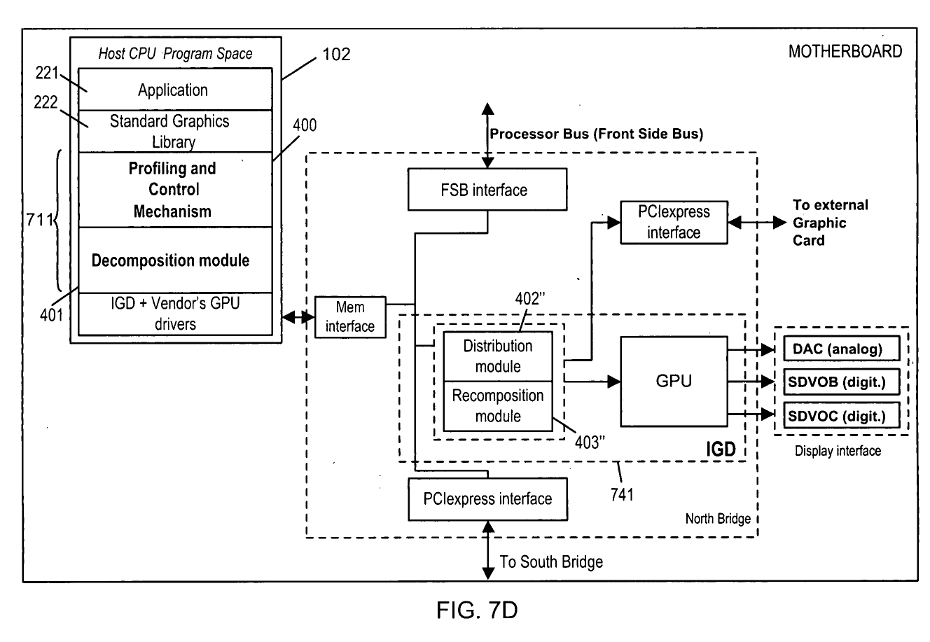

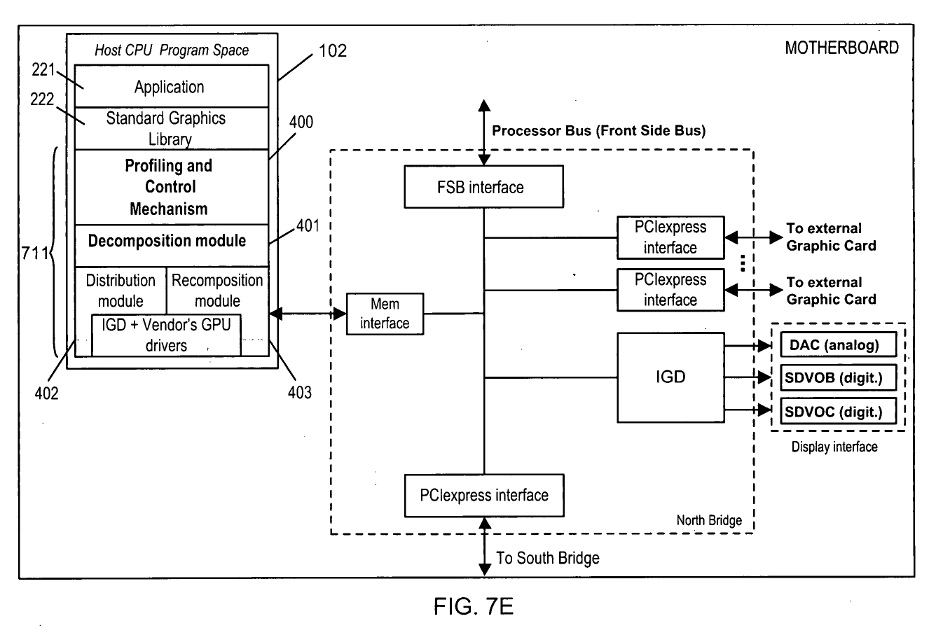

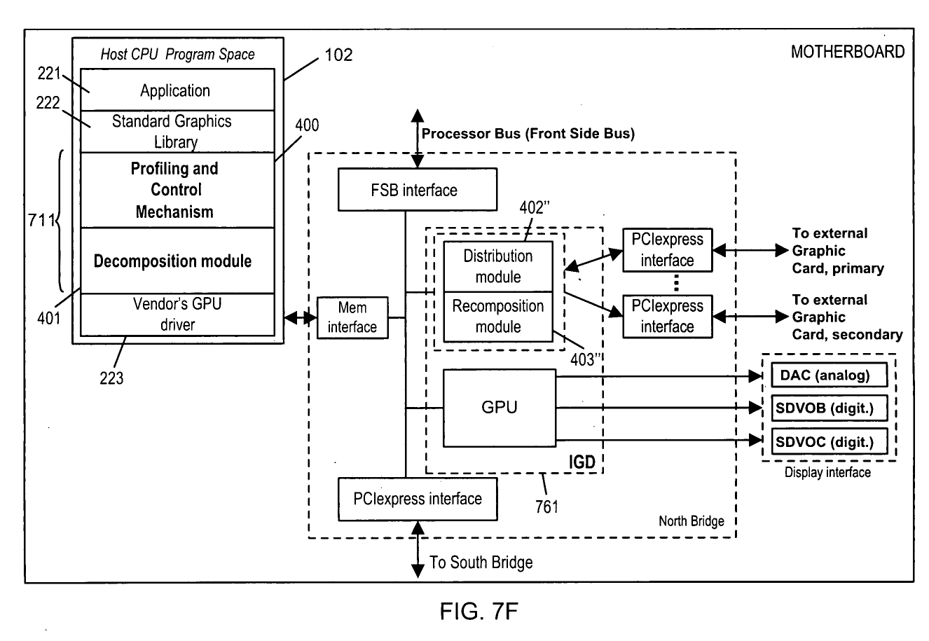

FIG. 7A shows an illustrative design for the MMPGRS of the present invention, having a software-based system architecture realized using a conventional PC platform having a dual-bus chipset interfaced with a Primary GPU 205 and a Secondary GPU 204 (i.e. Dual GPUs), with a Display unit (e.g. LCD panel, or LCD or DLP Projector) interfaced with the Primary GPU 205. The software package (701) supported in the Host CPU Memory Space comprises Profiling and Control Mechanism (PCM) (400) and a suit of three parallelism-enabling driving modules namely: the Decomposition Module (401), the Distribution Module (402) and the Recomposition Module (403).

### Illustrative Design for the Multi-Mode Parallel Graphics Rendering System of the Present Invention Having a Hardware (Hub-Based) System Architecture Parallelizing the Operation of Multiple GPUs

FIG. 7B shows an illustrative design for the MMPGRS of the present invention (710), having a hardware-based (i.e. Hub-based) system architecture, and realized using a conventional PC architecture provided with a single-bus chipset, and a hardware Graphics Hub, interconnected to cluster of GPUs (717) including a primary GPU (715 primary) attached to a Display (e.g. LCD panel, or LCD or DLP Projector) and number of secondary GPUs (715). As shown, this illustrative system architecture comprises a software package (711) including Profiling and Control Mechanism (PCM) (400), and a Decomposition Module (401). This a hardware (hub-based) system architecture is capable of parallelizing the operation of multiple GPUs according to the multi-mode parallel graphics rendering processes of the present invention.

Illustrative Design for the Multi-Mode Parallel Graphics Rendering System of the Present Invention Having a Hardware-Based System Architecture with an Integrated Graphics Device (IgD) on the Chipset Level Capable of Parallelizing the Operation of Multiple Gpus on the Chipset

FIG. 7C shows an illustrative design for the MMPGRS of the present invention having a hardware-based system architecture implemented in part on a chipset (e.g. North Bridge) as an IGD employing multiple GPUs, rather than on an external graphic card. The MMPGRS also includes a pair of software modules, including a Profiling and Control Mechanism (400) and Decomposition Module (401), residing in the host (CPU) program space (102) on the host system. As shown in the illustrative embodiment, the Distribution Module (402″), the Recomposition Module (403″) and cluster of built-in GPUs, are realized as silicon components of the IGD chipset. This a hardware-based system architecture is capable of parallelizing the operation of multiple GPUs according to the multi-mode parallel graphics rendering processes of the present invention.

Notably, the chipset embodying the IGD of present invention conveys two separate operational modes: an adaptive module, wherein GPUs on the IGD chipset are controlled by Profiling and Control Mechanism (PCM) as described hereinabove; and a regular mode, wherein the GPUs on one or more external graphics cards are controlled by the external graphics card (EGC) driver(s) within host memory space, shown in FIG. 7C.

Illustrative Design for the Multi-Mode Parallel Graphics Rendering System of the Present Invention, Having a Hardware-Based System Architecture with an Integrated Graphics Device (IgD) on the Chipset Level and Capable of Parallelizing the Operation of Multiple Gpus Supported on External Graphics Cards

FIG. 7D shows an illustrative design for the multi-mode parallel 3D graphics rendering system of present invention, having a hardware system architecture implemented in part on a chipset level as an IGD of the present invention employing a single GPU, capable of parallel operation in conjunction with one or more GPUs supported on an external graphic card (via a PCIexpress interface or the like). The software portion of this system architecture comprise Decomposition module (401), and Profiling and Control Mechanism (400), both residing in host (CPU) program space (102) of the host system. The IGD of present invention comprises silicon based Distribution module (402″), Recomposition module (403″), and single integrated GPU. In contrast to the previous IGD implementation shown in FIG. 7C, here an external graphics card is attached to the IGD so that the GPU(s) on the graphics card are capable of operating in parallel with the internal GPU.

Illustrative Design for the Multi-Mode Parallel Graphics Rendering System of the Present Invention Having a Software-Based System Architecture Capable of Parallelizing the Operation of a GPU Integrated within an IgD and Multiple GPUs on External Graphics Cards

FIG. 7E shows an illustrative design for the multi-mode parallel graphics rendering system of present invention, having a software-based architecture capable of parallelizing the operation of the chipset's integrated GPU with the GPUs on one or more external graphic cards. As shown, all four components are software based, residing in host CPU program space, namely: the Decomposition Module (401), the Distribution Module (402), the Recomposition Module (403), and the Profiling and Control Mechanism (400).

Illustrative Design for the Multi-Mode Parallel Graphics Rendering System of the Present Invention Having a Hardware System Architecture with an Integrated Graphics Device (IgD) on the Chipset Level and Capable of Controlling the Operation of a Single Integrated GPU or Parallelizing the Operation of Multiple GPUs on a Cluster of External Graphic Cards.

FIG. 7F shows an illustrative hardware-based architecture of the multi-mode parallel 3D graphics rendering system of present invention implemented on a chipset level as an IGD of the present invention capable of controlling a single integrated GPU, or parallelizing the operation of multiple GPUs on a cluster of external graphic cards. As shown in this system design, the components of the MMGPRS of present invention are split between software and hardware components. The software components are the Profiling and Control Mechanism (400), and the Decomposition Module (401), and both of these system components are realized in host CPU program space. The hardware components are the Distribution Module (402″) and the Recomposition Module (403″), and both of these system components are realized as part of the IGD of the present invention. In this system design, the MMPGRS of present invention drives multiple external graphic cards, while the chipset's integrated GPU is not part of the parallelization scheme. Therefore the IGD of present invention has two distinct operational modes: (i) a first mode in which the operation of multiple external GPUs are parallelized during graphics rendering; and (ii) a second mode, in which a single GPU integrated within the IGS is controlled.

### Various Options for Implementing the MMPGRS of the Present Invention

There are various options for implementing the various possible designs for the MMPGRS of the present invention taught herein. Also, as the inventive principles of the MMPGRS can be expressed using software and hardware based system architectures, the possibilities for the MMPGS are virtually endless.

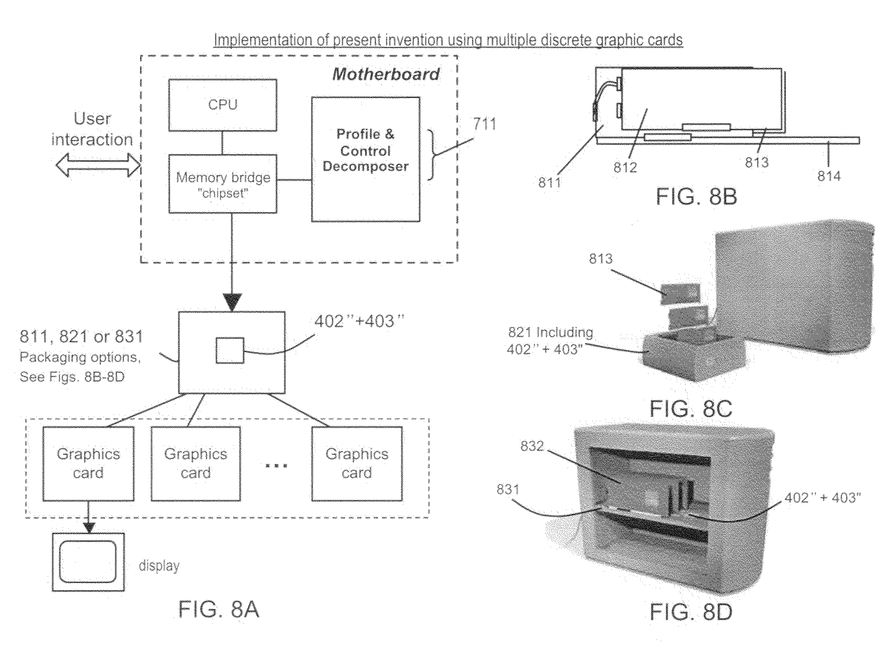

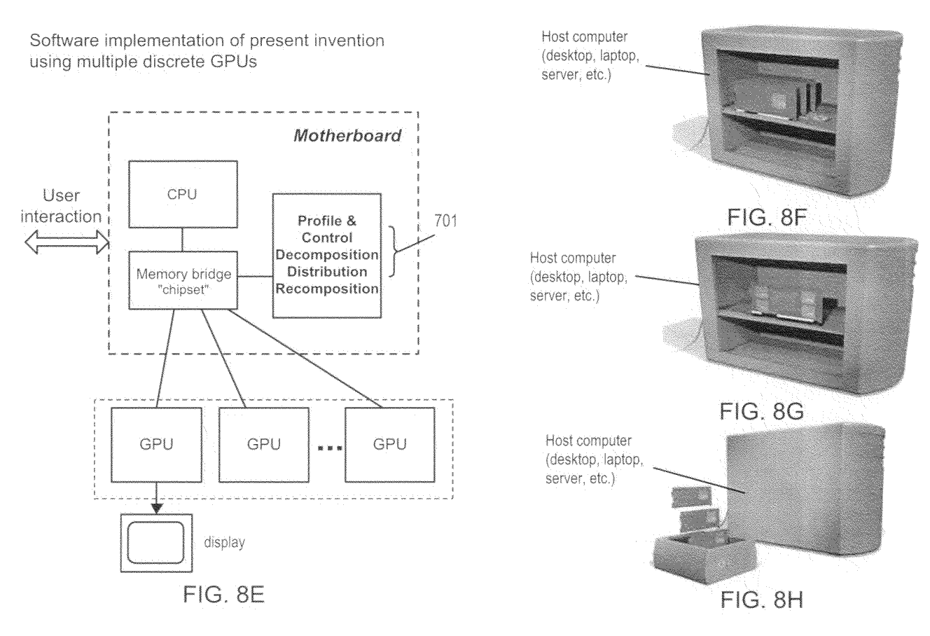

In FIGS. 8A through 11B2, there is shown just a sampling of the illustrative implementations that are possible for the MMPGRS of the present invention.

FIG. 8A shows an illustrative implementation of a hardware-based design for the multi-mode parallel graphics rendering system of the present invention, using multiple discrete graphic cards and hardware-based distribution and recomposition modules or components (402″ and 403″) realized on a hardware-based graphics hub of the present invention, as shown in FIG. 7B.

FIG. 8B shows a first illustrative hardware-based embodiment of the multi-mode parallel graphics rendering system of FIG. 8A, wherein the hardware-based distribution and recomposition modules (402″ and 403″) associated with the hardware-based hub of the present invention are realized as a chip or chipset on a discrete interface board (811), that is interfaced with the CPU motherboard (814), along with multiple discrete graphics cards (813 and 814), supporting multiple GPUs, are interfaced using a PCIexpress or like interface.

FIG. 8C shows a second illustrative hardware-based embodiment of the multi-mode parallel graphics rendering system of FIG. 8A, wherein the hardware-based distribution and recomposition modules (402″ and 403″) associated with the hardware-based graphics hub of the present invention are realized as a chip or chipset on a board attached to an external box (821), to which multiple discrete graphics cards (813), supporting multiple GPUs, are interfaced using a PCIexpress or like interface.

FIG. 8D shows a third illustrative hardware-based embodiment of the multi-mode parallel graphics rendering system of FIG. 8A, wherein the hardware-based distribution and recomposition modules (402″ and 403″) associated with the hardware-based graphics hub of the present invention are realized in a chip or chipset on the CPU motherboard (831), to which multiple discrete graphics cards (832), supporting multiple GPUs, are interfaced using a PCIexpress or like interface.

FIG. 8E shows an illustrative embodiment of a software-based implementation of the multi-mode parallel graphics rendering system of the present invention, wherein software-based decomposition, distribution and recomposition modules (701) are implemented within host memory space of the host computing system, for parallelizing the graphics rendering operations of multiple discrete GPUs, as illustrated in FIG. 7A.

FIG. 8F shows a first illustrative embodiment of a software-based implementation of the multi-mode parallel graphics rendering system of FIG. 8E, wherein discrete dual (or multiple) graphics cards (each supporting a single GPU) are interfaced with the CPU motherboard by way of a PCIexpress or like interface, as illustrated in FIG. 7A.

FIG. 8G shows a second illustrative embodiment of a software-based implementation of the multi-mode parallel graphics rendering system of FIG. 8E, wherein multiple GPUs are realized on a single graphics card which is interface to the CPU motherboard by way of a PCIexpress or like interface.

FIG. 8H shows a third illustrative embodiment of a software-based implementation of the multi-mode parallel graphics rendering system of FIG. 8E, wherein multiple discrete graphics cards (each having a single GPU) are interfaced with a board within an external box that is interface to the motherboard within the host computing system.

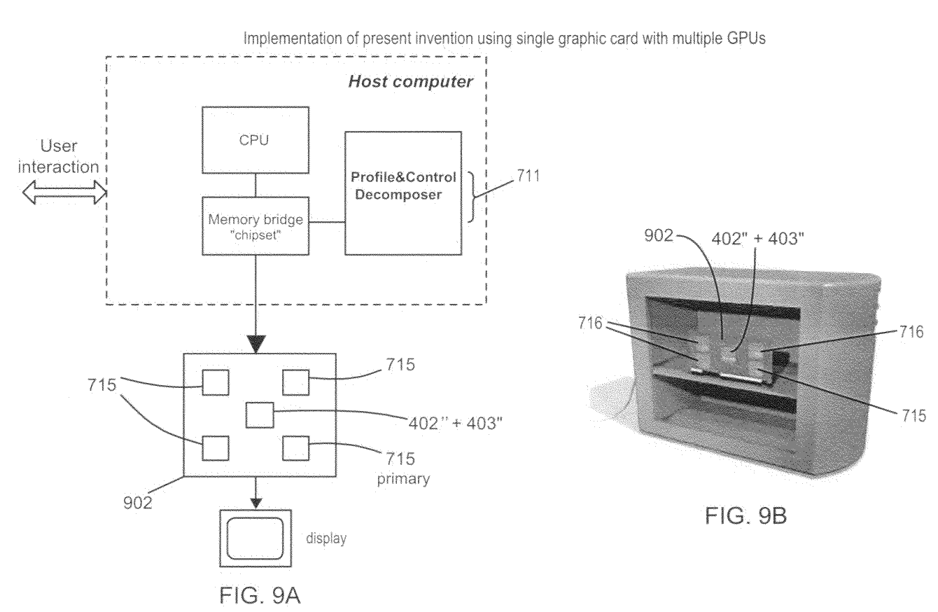

FIG. 9A shows a generalized hardware implementation of the multi-mode parallel graphics rendering system of the present invention. As shown, multiple GPUs (715) and hardware-based distribution and recomposition (hub) components (402″ and 403″) the present invention are implemented on a single graphics display card (902), and to which the display device is attached, as illustrated in FIG. 7B.

FIG. 9B shows an illustrative embodiment of the multi-mode parallel graphics rendering system of FIG. 9A. As shown, multiple GPUs (715) and hardware-based distribution and recomposition (hub) components (402″ and 403″) of the present invention are implemented on a single graphics display card (902), which is interfaced to the motherboard within the host computing system, and to which the display device is attached, as shown in FIG. 7B.

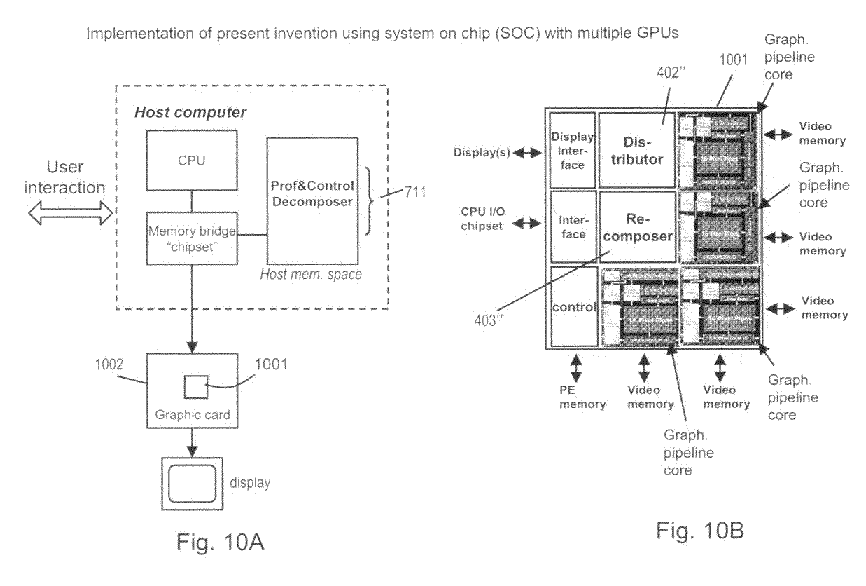

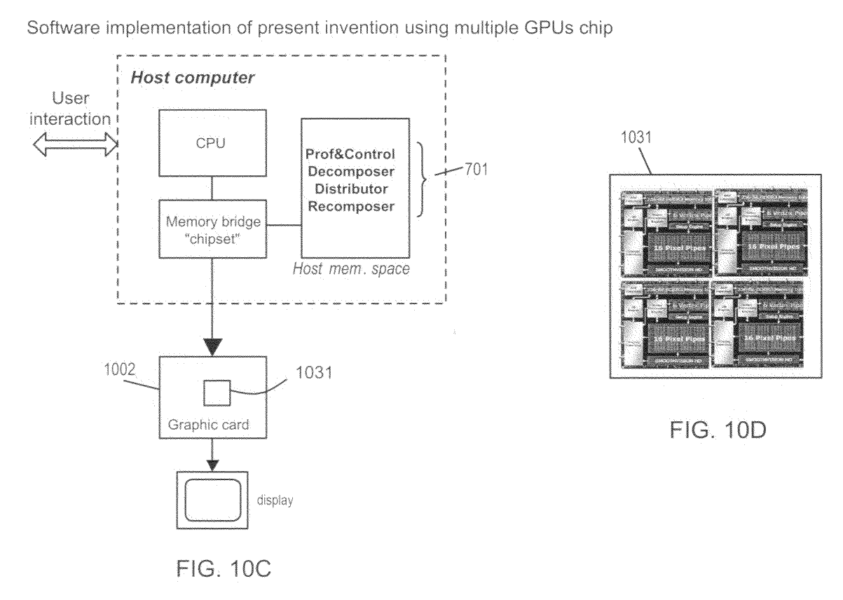

FIG. 10A shows a generalized hardware implementation of the multi-mode parallel graphics rendering system of the present invention realized using system on chip (SOC) technology. As shown, multiple GPUs and the hardware-based distribution and recomposition modules are implemented in a single SOC-based graphics chip (1001) mounted on a single graphics card (1002), while the software-based decomposition module is implemented in host memory space of the host computing system.

FIG. 10B shows an illustrative embodiment of a SOC implementation of the multi-mode parallel graphics rendering system of FIG. 10A. As shown, multiple GPUs and hardware distribution and recomposition components are realized on a single SOC implementation of the present invention (1001) on a single graphics card (1002), while the software-based decomposition module is implemented in host memory space of the host computing system.

FIG. 10C shows an illustrative embodiment of the multi-mode parallel graphics rendering system of the present invention, employing a multiple GPU chip installed on a single graphics display card which is interfaced to the motherboard of the host computing system by way of a PCIexpress or like bus, and the software-based decomposition, distribution, and recomposition modules of the present invention are implemented within the host memory space of the computing system. As shown, a display device is attached to the single graphics card, as illustrated in FIG. 7A.

FIG. 10D shows an illustrative embodiment of the multi-mode parallel graphics rendering system of FIG. 10C, employing a multiple GPU chip installed on a single graphics display card which is interfaced to the motherboard of the host computing system by way of a PCIexpress or like bus, and the software-based decomposition, distribution, and recomposition modules of the present invention are implemented within the host memory space of the computing system.

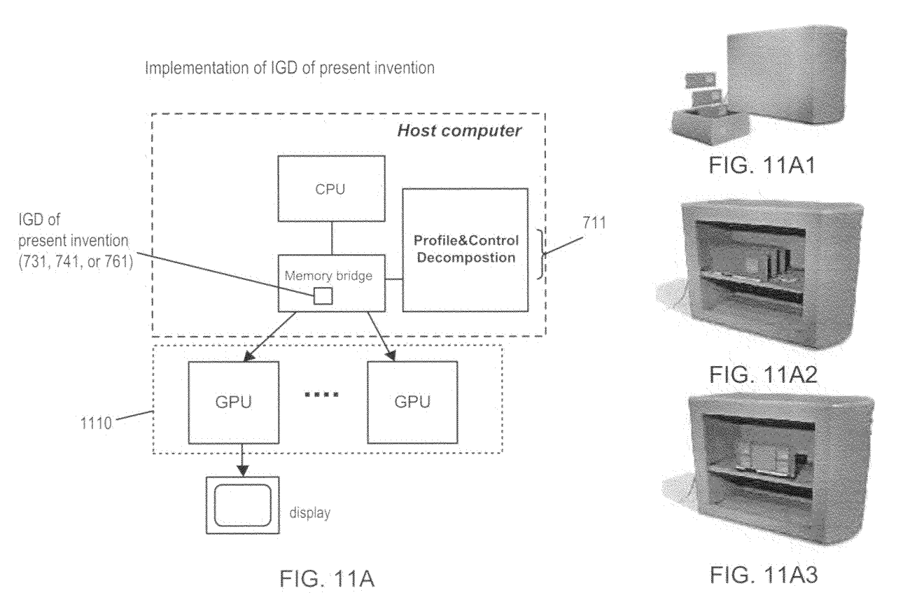

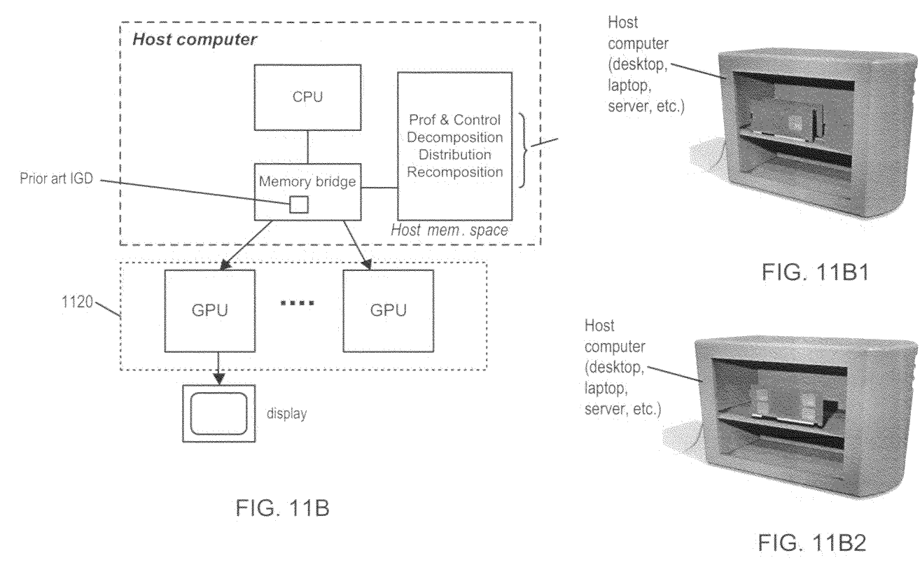

FIG. 11A shows an illustrative embodiment of the multi-mode parallel graphics rendering system of FIGS. 7C, 7D and 7F, wherein (i) an integrated graphics device (IGD, 1101) supporting the hardware-based distribution and recomposition modules of present invention is implemented within the memory bridge (1101) chip on the motherboard of the host computing system, (ii) the software-based decomposition and distribution modules of the present invention are realized within the host memory space of the host computing system, and (iii) multiple graphics display cards (717) are interfaced to the IDG by way of a PCIexpress or like interface, and to which the display device is attached.

FIG. 11A1 shows a first illustrative embodiment of the multi-mode parallel graphics rendering system of FIG. 11A, wherein (i) the integrated graphics device (IGD 1112) is realized within the memory bridge (1111) on the motherboard of the host computing system, (ii) the software-based decomposition module of the present invention is realized within the host (CPU) memory space of the computing system, and (iii) multiple graphics display cards (717) (supporting multiple GPUs) are interfaced to a board within an external box. As shown, the graphics display cards are interface to the IDG by way of a PCIexpress or like interface.

FIG. 11A2 shows a second illustrative embodiment of the multi-mode parallel graphics rendering system of FIG. 11A. As shown, (i) the integrated graphics device (IGD 1112) is realized within the memory bridge (1111) on the motherboard of the host computing system, (ii) the software-based decomposition module of the present invention is realized within the host memory space of the host computing system, and (iii) multiple graphics display cards (717) each with a single GPU are interface to the IDG by way of a PCIexpress or like interface.

FIG. 11A3 shows a third illustrative embodiment of the multi-mode parallel graphics rendering system of FIG. 11A. As shown, (i) the integrated graphics device (IGD 1112) is realized within the memory bridge (1111) on the motherboard of the host computing system, (ii) the software-based decomposition module of the present invention is realized within the host memory space of the host computing system, and (iii) multiple GPUs on a single graphics display card (717) are connected to the IDG by way of a PCIexpress or like interface.

FIG. 11B shows an illustrative embodiment of the multi-mode parallel graphics rendering system of FIG. 7E. As shown, (i) a prior art (conventional) integrated graphics device (IGD) is implemented within the memory bridge (1101) chip on the motherboard of the host computing system, (ii) the software-based decomposition, distribution and recomposition modules of the present invention (701) are realized within the host memory space of the host computing system, and (iii) multiple GPUs (1120) are interfaced to the conventional IDG by way of a PCIexpress or like interface, and to which the display device is attached.

FIG. 11B1 shows a first illustrative embodiment of the multi-mode parallel graphics rendering system of FIG. 11B. As shown, (i) the conventional IGD is realized within the memory bridge on the motherboard of the host computing system, (ii) the software-based decomposition, distribution and recomposition modules of the present invention (701) are realized within the host (CPU) memory space of the computing system, and (iii) multiple graphics display cards (each supporting a single GPU) are interfaced to the motherboard of the host computing system by way of a PCIexpress or like interface.

FIG. 11B2 shows a second illustrative embodiment of the multi-mode parallel graphics rendering system of FIG. 11B. As shown, (i) the conventional IGD is realized within the memory bridge on the motherboard of the host computing system, (ii) the software-based decomposition, distribution and recomposition modules of the present invention (701) are realized within the host (CPU) memory space of the computing system, and (iii) a single graphics display card (supporting multiple GPUs) is interfaced to the motherboard of the host computing system by way of a PCIexpress or like interface, and to which the display device is connected.

### The MMPGRS of the Present Invention Deployed in Client Machines on Multi-User Computer Networks

In the illustrative embodiments described above, the Applications (e.g. games, simulations, business processes, etc.) supporting 3D graphics processes which are rendered using the parallel computing principles of the present invention, have been shown as being supported on single CPU-based host computing platforms.

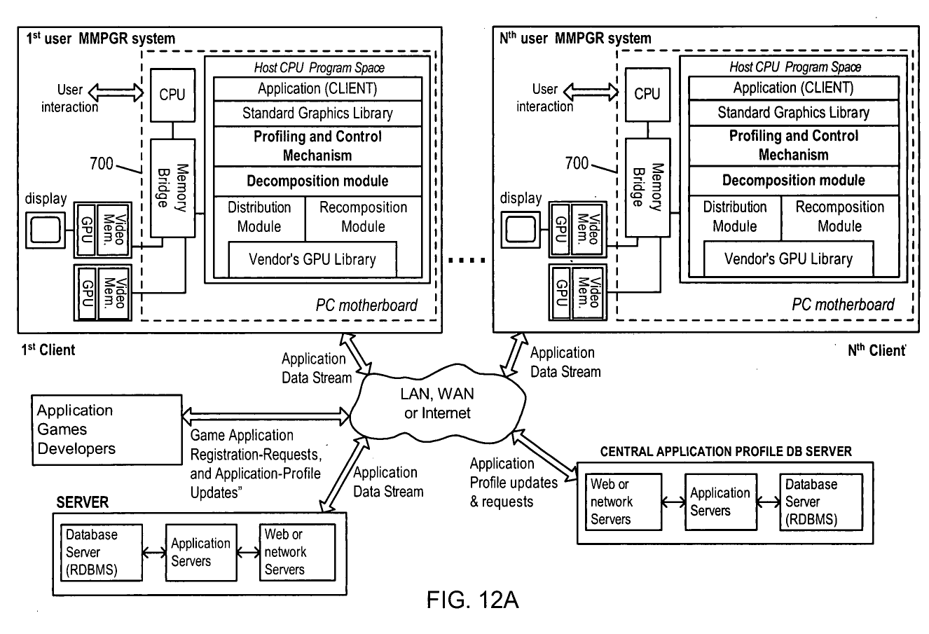

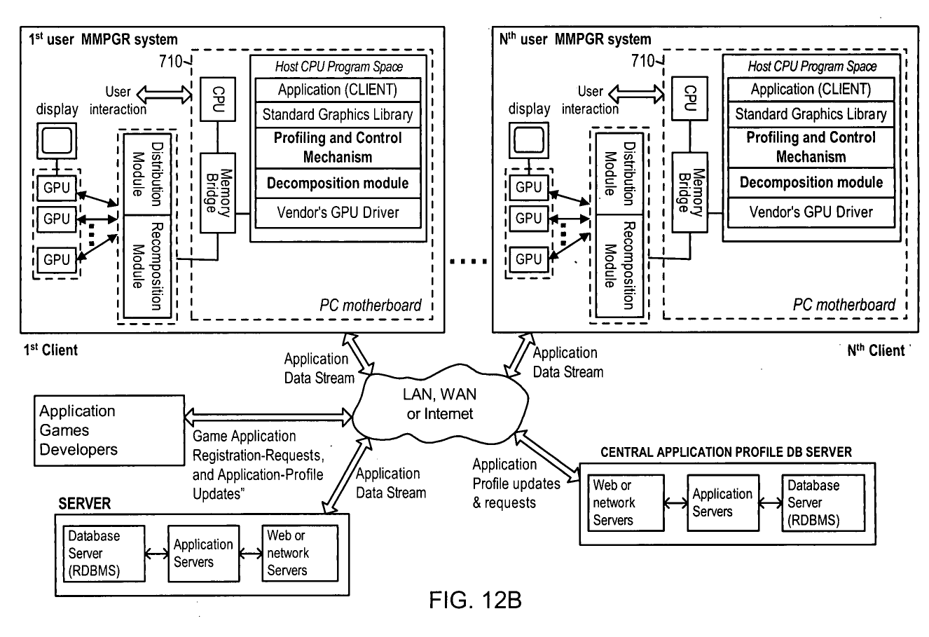

It is understood, however, that parallel graphics rendering processes carried out by the present invention can stem from Applications supported on (i) multi-CPU host computing platforms, as well as (ii) network-based application servers. In the case of network-based application servers, streams of graphics commands and data pertaining to the Application at hand can be generated by Application server(s) in response to one or more multiple users (e.g. players) who may be either local or remote with respect to each other. The Application servers would transmit streams of graphics commands and data to the participants (e.g. users or players) of a multi-player game. The client-based computing machine of each user would embody one form of the MMPGRS of the present invention, and receive the graphics commands and data streams support the client-side operations of either (i) a client-server based Application (running at the remote Application servers), and/or (ii) a Web-based Application generated from http (Web) servers interfaced to Application Servers, driven by database servers, as illustrated in FIGS. 12A and 12B. In such multi-user computer network environments, the MMPGRS aboard each client machine on the network would support its parallel graphics rendering processes, as described in great detail hereinabove, and composited images will be displayed on the display device of the client machine. Display devices available to the users of a particular Application can include LCD panels, plasma display panels, LCD or DLP based multi-media projectors and the like.

FIG. 12A shows a first illustrative embodiment of the multi-user computer network according to the present invention, comprising a plurality of client machines, wherein one or more client machines embody the MMPGRS of the present invention designed using the software-based system architecture of FIG. 7A. In FIG. 12B, a second illustrative embodiment of the multi-user computer network of the present invention, is shown comprising a plurality of client machines, wherein one or more client machines embody the MMPGRS of the present invention designed using the hardware-based system architecture of FIG. 7B. In either network design, the Application server(s), driven by one or more database servers (RDBMS) on the network, and typically supported by a cluster of communication servers (e.g. running http), respond to user-system interaction input data streams that have been transmitted from one or more network users on the network. Notably, these user (e.g. gamers or players) might be local each other as over a LAN, or be remote to each other as over a WAN or the Internet infrastructure. In response to such user-system interaction, as well as Application profiling carried out in accordance with the principles of the present invention, the MMPGRs aboard each client machine will automatically control, in real-time, the mode of parallel graphics rendering supported by the client machine, in order to optimize the graphics performance of the client machine.

Using a Central Application Profile Database (DB) Server System to Automatically Update Over the Internet, Graphic Application Profiles (Gaps) within the MMPGRs of Client Machines

It is with the scope and spirit of the present invention to ensure that each MMPGRS is optimally programmed at all possible times so that it quickly and continuously offers users high graphics performance through its adaptive multi-modal parallel graphics operation. One way to help carry out this objective is to set up a Central Application Profile Database (DB) Server System on the Internet, as shown in FIGS. 12A and 12B, and support the various Internet-based application registration and profile management and delivery services, as described hereinbelow.

As shown in FIGS. 12A and 12B, the Central Application Profile Database (DB) Server System of the illustrative embodiment comprises a cluster of Web (http) servers, interfaced with a cluster of application servers, which in turn are interfaced with one or more database servers (supporting RDBMS software), well known in the art. The Central Application Profile Database (DB) Server System would support a Web-based Game Application Registration and Profile Management Application, providing a number of Web-based services, including:

(1) the registration of Game Application Developers within the RDBMS of the Server;

(2) the registration of game applications with the RDBMS of the Central Application Profile Database (DB) Server System, by registered game application developers;

(3) registration of each MMPGRS deployed on a client machine or server system having Internet-connectivity, and requesting subscription to periodic/automatic Graphic Application Profile (GAP) Updates (downloaded to the MMPGRS over the Internet) from the Central Application Profile Database (DB) Server System; and

(4) registration of each deployed MMPGRS requesting the periodic uploading of its Game Application Profiles (GAPS)—stored in Behavorial Profile DB 405 and Historical Repository 404—to the Central Application Profile Database (DB) Server System for the purpose of automated analysis and processing so as to formulate “expert” Game Application Profiles (GAPs) that have been based on robust user-experience and which are optimized for particular client machine configurations.

Preferably, the Web-based Game Application Registration and Profile Management Application of the present invention would be designed (using UML techniques) and implemented (using Java or C+) so as to provide an industrial-strength system capable of serving potentially millions of client machines embodying the MMPGRS of the present invention.

Using the Central Application Profile Database (DB) Server System of the present invention, it is now possible to automatically and periodically upload, over the Internet, Graphic Application Profiles (GAPs) within the Behavorial Profile DB 405 of the MMPGRS of registered client machines. By doing so, graphic application users (e.g. gamers) can immediately enjoy high performance graphics on the display devices of their client machines, without having to develop a robust behavioral profile based on many hours of actual user-system interaction, but rather, automatically periodically uploading in their MMPGRSs, “expert” GAPs generated by the Central Application Profile Database (DB) Server System by analyzing the GAPs of thousands of game application users connected to the Internet.

For MMPGRS users subscribing to this Automatic GAP Management Service, supported by the Central Application Profile Database (DB) Server System of the present invention, it is understood that such MMPGRSs would use a different type of Application Profiling and Analysis than that disclosed in FIGS. 5A1 and 5A2.

For Automatic GAP Management Service subscribers, the MMPGRS would preferably run an application profiling and analysis algorithm that uses the most recently downloaded expert GAP loaded into its PCM, and then allow system-user interaction, user behavior, and application performance to modify and improve the expert GAP profile over time until the next automated update occurs.

Alternatively, the Application Profiling and Analysis Module in each MMGPRS subscribing to the Automatic GAP Management Service, will be designed to that it modifies and improves the downloaded expert GAP within particularly set limits and constraints, and according to particular criteria, so that the expert GAP is allowed to evolve in an optimal manner, without performance regression.

For users, not subscribing to the Automatic GAP Management Service, Application Profiling and Analysis will occur in their MMPGRSs according to general processes described in FIGS. 5A1 and 5A2.

Variations of the Present Invention which Readily Come to Mind in View of the Present Invention Disclosure

While the illustrative embodiments of the present invention have been described in connection with various PC-based computing system applications, it is understood that that multi-modal parallel graphics rendering subsystems, systems and rendering processes of the present invention can also be used in video game consoles and systems, mobile computing devices, e-commerce and POS displays and the like.

While Applicants have disclosed such subsystems, systems and methods in connection with Object, Image and Time Division methods being automatically instantiated in response to the graphical computing needs of the application(s) running on the host computing system at any instant in time, it is understood, however, that the MMPGRS of the present invention can be programmed with other modes of 3D graphics rendering (beyond Object, Image and Time Division), and that these modes can be based on novel ways of dividing and/or quantizing: (i) objects and/or scenery being graphically rendered; (ii) the graphical display screen (on which graphical images of the rendered object/scenery are projected); (iii) temporal aspects of the graphical rendering process; (iv) the illumination sources used during the graphical rendering process using parallel computational operations; as well as (v) various hybrid combinations of these components of the 3D graphical rendering process.

It is understood that the multi-modal parallel graphics rendering technology employed in computer graphics systems of the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1. An Internet-based application profile database server system for updating graphic application profiles (GAPs) stored within a behavorial profile database in a multi-mode parallel graphics rendering system (MMPGRS) embodied within a client machine running one or more graphic applications, wherein each said graphics application has a graphic application profile (GAP), and each said client machine has a behavior profile associated with the running of a particular graphics application on said client machine, said Internet-based application profile database server system comprising:
an Internet server, interfaced with a RDBMS, for communicating with one or more said client machines over a communication network, such as the Internet, and programming one or more GAPs in each said client machine so that said client machine supports users with high graphics performance through adaptive multi-modal parallel graphics operation.

2. The Internet-based application profile database server system of claim 1, wherein said internet server supports a web-based game application registration and profile management application, that provides a number of Web-based services, selected from the group consisting of:
(1) the registration of game application developers within said RDBMS;
(2) the registration of game applications with said RDBMS, by registered game application developers;
(3) the registration of each MMPGRS deployed on a client machine or server system having Internet-connectivity, and requesting subscription to periodic/automatic Graphic Application Profile (GAP) Updates (downloaded to said MMPGRS over the Internet) from said Internet server; and
(4) the registration of each deployed MMPGRS requesting the periodic uploading of its Game Application Profiles (GAPS) to said Internet server for the purpose of automated analysis and processing so as to formulate “expert” GAPs that have been based on robust user-experience and which are optimized for particular client machine configurations.

3. The Internet-based application profile database server system of claim 1, wherein said Internet server enables the MMGPRS of each registered client machine to automatically and periodically upload, over the Internet, GAPs within said behavorial profile database of the MMPGRS.

4. The Internet-based application profile database server system of claim 1, wherein by enabling the automatic uploading of expert GAPs into said MMPGRS, graphic application users (e.g. gainers) can immediately enjoy high performance graphics on the display devices of their client machines, without having to develop a robust behavioral profile based on many hours of actual user-system interaction.

5. The Internet-based application profile database server system of claim 1, wherein “expert” GAPs are automatically generated by said Internet-based application profile database server system by analyzing the GAPs of thousands of game application users connected to the Internet.

6. The Internet-based application profile database server system of claim 2, wherein for client machine users subscribing to the automatic gap management services, each such MMPGRS runs an application profiling and control algorithm that uses the most recently uploaded expert GAP loaded into said behavorial profile database, and then allow system-user interaction, user behavior, and application performance to modify the expert GAP profile over time until the next update occurs.

7. The Internet-based application profile database server system of claim 1, wherein an Application Profiling and Analysis Module provided in each said MMGPRS subscribing to the automatic gap management services supported by said Internet-based application profile database server system, modifies and improves the expert GAP within particularly set limits and constraints, and according to particular criteria, so that the expert GAP is allowed to evolve in an optimal manner, without performance regression.

8. An Internet-based system for communicating with one or more client machines over a communication network, comprising:
one or more client machines, each having a multi-mode parallel graphics rendering system (MMPGRS) with a behavorial profile database for storing (i) graphic application profiles (GAPs) graphic applications associated with particular graphics applications, and (ii) a behavior profile associated with the running of a particular graphics application on said client machine; and
an Internet server, interfaced with a RDBMS, for communicating with said one or more said client machines over a communication network, such as the Internet, and programming one or more GAPs in each said client machine so that said client machine supports users with high graphics performance through adaptive multi-modal parallel graphics operation.

9. The Internet-based system of claim 8, wherein said Internet server supports a web-based game application registration and profile management application, that provides a number of Web-based services, selected from the group consisting of:
(1) the registration of game application developers within said RDBMS;
(2) the registration of game applications with said RDBMS, by registered game application developers;
(3) the registration of each MMPGRS deployed on a client machine or server system having Internet-connectivity, and requesting subscription to periodic/automatic Graphic Application Profile (GAP) Updates (downloaded to said MMPGRS over the Internet) from said Internet server; and
(4) the registration of each deployed MMPGRS requesting the periodic uploading of its Game Application Profiles (GAPS) to said Internet server for the purpose of automated analysis and processing so as to formulate “expert” GAPs that have been based on robust user-experience and which are optimized for particular client machine configurations.

10. The Internet-based application profile database server system of claim 8, wherein said Internet server enables the MMGPRS of each registered client machine to automatically and periodically upload, over the Internet, GAPs within said behavorial profile database of the MMPGRS.

11. The Internet-based application profile database server system of claim 8, wherein by enabling the automatic uploading of expert GAPs into said MMPGRS, graphic application users (e.g. gamers) can immediately enjoy high performance graphics on the display devices of their client machines, without having to develop a robust behavioral profile based on many hours of actual user-system interaction.

12. The Internet-based application profile database server system of claim 8, wherein “expert” GAPs are automatically generated by said Internet-based system by analyzing the GAPs of thousands of game application users connected to the Internet.

13. The Internet-based application profile database server system of claim 8, wherein for client machine users subscribing to the automatic gap management services, each said MMPGRS runs an application profiling and control algorithm that uses the most recently uploaded expert GAP loaded into said behavior profile database and then allow system-user interaction, user behavior, and application performance to modify the expert GAP profile over time until the next update occurs.

14. The Internet-based application profile database server system of claim 8, wherein an Application Profiling and Analysis Module provided in each said MMGPRS subscribing to the automatic gap management services supported by said Internet-based application profile database server system, modifies and improves the expert GAP within particularly set limits and constraints, and according to particular criteria, so that the expert GAP is allowed to evolve in an optimal manner, without performance regression.

15. A multi-user computer network comprising:
a plurality of client machines operably connected to the infrastructure of the Internet,
wherein each client machine employs a multi-mode parallel graphics rendering system (MPGRS) which is responsive to user-interaction input data streams from one or more said client machines which can be local each other as over a LAN, or be remote to each other as over a WAN or the Internet infrastructure.

16. The multi-user computer network of claim 15, wherein said MMPGRS in at least one said client machine is implemented using a hardware-based architecture.
